(19) United States
(12) Patent Application Publication
(10) Pub. No.: US 2017/0201639 A1
(43) Pub. Date: Jul. 13, 2017

(54) IMAGE FORMING APPARATUS AND RECORDING MEDIUM

(71) Applicant: KONICA MINOLTA, INC., Tokyo (JP)

(72) Inventor: Masaaki SAKA, Toyohashi-shi (JP)

(73) Assignee: KONICA MINOLTA, INC., Tokyo (JP)

(21) Appl. No.: 15/393,328

(22) Filed: Dec. 29, 2016

(30) Foreign Application Priority Data
Jan. 8, 2016 (JP) 2016-003011

(51) Int. Cl. H04N 1/00

(52) U.S. Cl. CPC H04N 1/00514; H04N 1/00387; H04N 1/00411; H04N 2201/0094

(57) ABSTRACT

An image forming apparatus has a first user interface operating on a first platform and a second user interface operating on a second platform and capable of being customized by a user. When a user operation is performed in a customized screen of the second user interface, the image forming apparatus determines recognition information which is information to be used for recognizing an instruction content given by the user operation, among two types of information (action instruction information based on the user operation and information on an operation position of the user operation). When the information on the operation position of the user operation is determined as the recognition information, the image forming apparatus converts operation position information in the second user interface into operation element information and recognizes the instruction content on the basis of at least one of the action instruction information and the operation element information.

This application is based on Japanese Patent Application No. 2016-003011 filed on Jan. 8, 2016, the contents of which are hereby incorporated by reference.

### BACKGROUND OF THE INVENTION

Field of the Invention

The present invention relates to an image forming apparatus such as an MFP (Multi-Functional Peripheral) and its relevant technique.

Description of the Background Art

As a user interface system displayed on an operation part of an image forming apparatus such as an MFP or the like, as well as a system using an operation screen which is originally provided in the MFP, a system using a user-specific operation screen (my panel screen) which is customized for each user has been used (see Japanese Patent Application Laid Open Gazette No. 2012-168819 (Patent Document 1)).

Further, there is a technique in which on each of two different platforms constructed in the MFP, used is an individual user interface (implemented by software). One of these two user interfaces (the first user interface) is a user interface (referred to also as a “standard user interface”) operating on a platform for controlling the MFP (referred to also as a “standard platform”). The other one (the second user interface) is, for example, a user interface (hereinafter, referred to also as an “IWS (Internal Web Server) user interface”) operating on an “IWS platform”. Herein, the IWS platform refers to a platform for transmitting/receiving information between an internal web server which is provided inside the MFP and a web browser which is provided inside the MFP.

In the above first user interface (standard user interface), for example, there are many operation screens, and display buttons and the like for receiving many types of operations are provided.

Further, in the second user interface (e.g., IWS user interface), a user-specific operation screen (customized screen) which is customized for each user can be used. When each user customizes an operation screen (panel screen) in accordance with his own preference, the user can use a convenient operation screen (customized screen) in consideration of the frequency of use of each button, and the like.

In the conventional IWS user interface (customized screen), however, only main buttons can be customizably arranged, and some buttons cannot be used in the conventional IWS user interface (customized screen).

Herein, in order to transmit an instruction content given by a user operation (user manipulation) in the IWS user interface (customized screen) on the IWS platform, generally, provided is an interface (software interface) for performing transmission/reception of information between the standard platform and the IWS platform. In more detail, the interface is provided as an API (Application Programming Interface) or the like.

Conventionally, however, due to various circumstances, the APIs (APIs for cooperation between the two platforms) are prepared in advance only for some of all the buttons, i.e., for main buttons, in the standard user interface. In other words, among all the buttons in the standard user interface, there are some buttons for which corresponding APIs (APIs for cooperation between the two platforms) are not prepared. As a result, the button for which the corresponding API is not prepared cannot be used in the conventional IWS user interface. For this reason, as described above, there are some buttons which cannot be used in the conventional IWS user interface.

Then, additionally providing (additionally generating) an API for cooperation between the two platforms is one proposal for reducing the buttons which cannot be used in the customized screen. It is not preferable, however, to additionally provide a corresponding API for cooperation between the two platforms for each of all the many buttons since this needs a large number of steps for development.

### SUMMARY OF THE INVENTION

It is an object of the present invention to provide a technique which makes it possible to exclude any limitation due to whether or not there is an action instruction code for cooperation (API for cooperation, or the like) between two user interfaces and arrange relatively diverse buttons in a customized screen of one of the two user interfaces.

The present invention is intended for an image forming apparatus having a first user interface operating on a first platform and a second user interface operating on a second platform and capable of being customized by a user. According to a first aspect of the present invention, the image forming apparatus comprises a determination part for determining recognition information which is information to be used for recognizing an instruction content given by a user operation, among action instruction information based on the user operation and information on an operation position of the user operation, which are two different types of information, when the user operation is performed in a customized screen of the second user interface, a conversion part for converting operation position information in the second user interface into operation element information which is information of a corresponding operation element in a corresponding operation screen of the first user interface when the information on the operation position of the user operation is determined as the recognition information, and a recognition part for recognizing the instruction content given by the user operation on the basis of at least one of the action instruction information and the operation element information.

The present invention is also intended for a non-transitory computer-readable recording medium. According to a second aspect of the present invention, the non-transitory computer-readable recording medium records therein a computer program to be executed by a computer embedded in an image forming apparatus to realize a first user interface operating on a first platform and a second user interface operating on a second platform and capable of being customized by a user, to cause the computer to perform the steps of a) determining recognition information which is information to be used for recognizing an instruction content given by a user operation, among action instruction information based on the user operation and information on an operation position of the user operation, which are two different types of information, when the user operation is performed in a customized screen of the second user interface, b) converting operation position information in the second user interface into operation element information which is information of a corresponding operation element in a corresponding operation screen of the first user interface when the information on the operation position of the user operation is determined as the recognition information, and c) recognizing the instruction content given by the user operation on the basis of at least one of the action instruction information and the operation element information.

According to a third aspect of the present invention, the non-transitory computer-readable recording medium records therein a computer program to be executed by a computer embedded in an image forming apparatus to realize a first user interface operating on a first platform and a second user interface operating on a second platform and capable of being customized by a user, to cause the computer to perform the steps of a) determining information to be transferred from the second platform on which the second user interface operates to the first platform on which the first user interface operates, among information on an operation position of a user operation and action instruction information based on the user operation, which are two different types of information, when the user operation is performed in a customized screen of the second user interface, b) converting operation position information indicating the operation position of the user operation in the second user interface into operation element information on a corresponding operation screen in the first user interface and generating the operation element information as the information on the operation position of the user operation, when the information on the operation position of the user operation is determined to be transferred to the first platform, and c) transferring at least one of the action instruction information and the operation element information obtained after conversion in the step b), which is the information determined in the step a), from the second platform to the first platform, as recognition information which is information to be used in the first user interface for recognizing an instruction content given by the user operation performed in the second user interface.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing an overall configuration of an image forming system;

FIG. 2 is a diagram showing functional blocks of an MFP (image forming apparatus);

FIG. 3 is a diagram showing a software structure and the like in the MFP;

FIG. 4 is a view showing one operation screen in a standard user interface;

FIG. 5 is a view showing another operation screen in the standard user interface;

FIG. 6 is a view showing still another operation screen in the standard user interface;

FIG. 7 is a view showing a setting screen in an IWS user interface;

FIG. 8 is a flowchart showing an operation of the MFP;

FIG. 9 is a sequence diagram showing an operation of the present system;

FIG. 10 is a view showing an API information table;

FIG. 11 is a view showing a coordinate conversion table;

FIG. 12 is a diagram showing a software structure and the like in an MFP in accordance with a second preferred embodiment;

FIG. 13 is a flowchart showing an operation of the MFP in accordance with the second preferred embodiment;

FIG. 14 is a sequence diagram showing an operation of a system in accordance with the second preferred embodiment;

FIG. 15 is a view showing a customized screen in accordance with a third preferred embodiment;

FIG. 16 is a view showing another API information table;

FIG. 17 is a view showing another coordinate conversion table;

FIG. 18 is a sequence diagram showing an operation of a system in accordance with the third preferred embodiment; and

FIG. 19 is a sequence diagram showing an operation of a system in accordance with a variation.

### DESCRIPTION OF THE PREFERRED EMBODIMENTS

Hereinafter, the preferred embodiments of the present invention will be described with reference to the accompanying drawings.

### 1. The First Preferred Embodiment

<1-1. Overall Configuration>

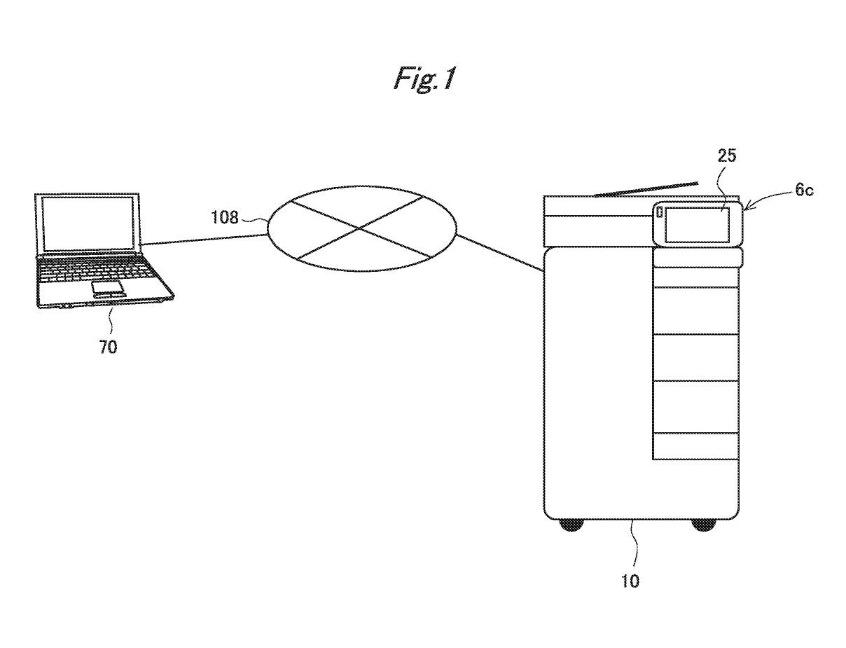

FIG. 1 is a view showing an image forming system 1 in accordance with the present invention. As shown in FIG. 1, the image forming system 1 comprises an image forming apparatus 10 and a client computer 70.

The constituent elements 10 and 70 in the present system 1 are communicably connected to each other via a network 108. The network 108 includes a LAN (Local Area Network), the internet, and the like. The connection to the network 108 may be wired or wireless.

In the client computer 70, installed is an application software program (hereinafter, also referred to simply as an “application”). In more detail, an application for generating a user interface (UI) (in more detail, a customized screen) in a touch panel 25 (the application is also referred to as a UI builder (customized screen generation application)) and the like operation, or the like is installed. By using the UI builder, a user can generate a customized screen. Further, when data and the like on the customized screen are transmitted to the image forming apparatus 10 by using the UI builder, the user can use the customized screen in the image forming apparatus 10.

<1-2. Constitution of Image Forming Apparatus>

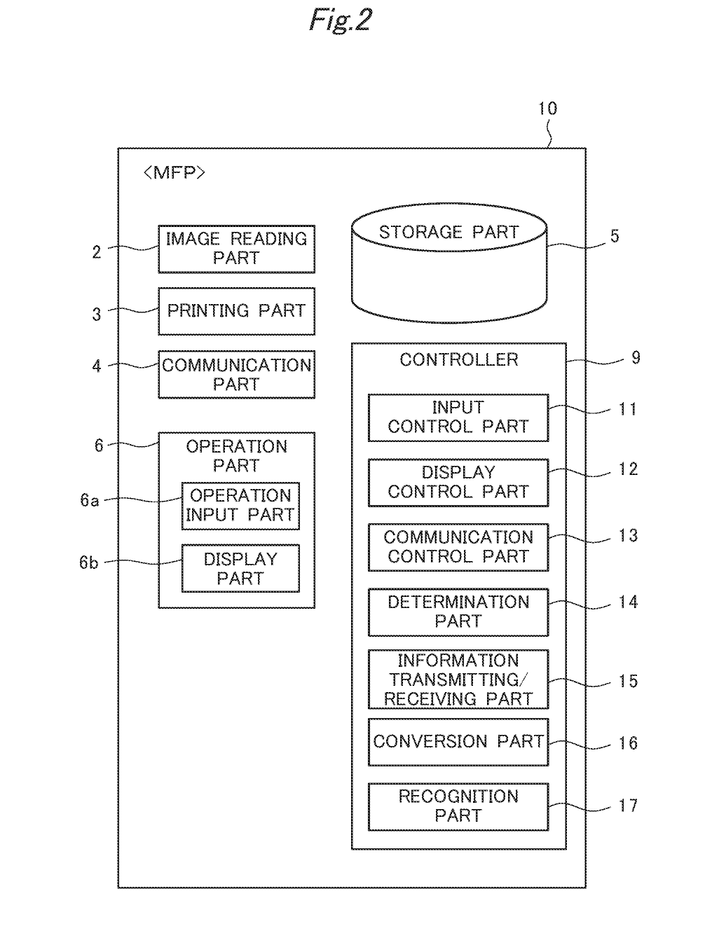

FIG. 2 is a diagram showing functional blocks of the image forming apparatus 10. Herein, as the image forming apparatus 10, exemplarily shown is an MFP (Multi-Functional Peripheral). FIG. 2 shows functional blocks of the MFP 10.

The MFP 10 is an apparatus (also referred to as a multifunction machine) having a scanner function, a copy function, a facsimile function, a box storage function, and the like. Specifically, as shown in the functional block diagram of FIG. 2, the MFP 10 comprises an image reading part 2, a printing part 3, a communication part 4, a storage part 5, an operation part 6, a controller 9, and the like, and multiply uses these constituent parts to implement various functions.

The image reading part 2 is a processing part which optically reads (in other words, scans) an original manuscript placed on a predetermined position of the MFP 10 and generates image data of the original manuscript (also referred to as an “original manuscript image” or a “scan image”). The image reading part 2 is also referred to as a scanning part.

The printing part 3 is an output part which prints out an image to various media such as paper on the basis of the data on an object to be printed.

The communication part 4 is a processing part capable of performing facsimile communication via public networks or the like. Further, the communication part 4 is also capable of performing communication (network communication) via a communication network.

The storage part 5 is a storage unit such as a hard disk drive (HDD) or/and the like.

The operation part 6 comprises an operation input part 6a for receiving an operation input which is given to the MFP 10 and a display part 6b for displaying various information thereon.

The MFP 10 is provided with a substantially plate-like operation panel part 6c (see FIG. 1). The operation panel part 6c has a touch panel 25 (see FIG. 1) on a front surface side thereof. The touch panel 25 serves as part of the operation input part 6a and also serves as part of the display part 6b. The touch panel 25 is a liquid crystal display panel in which various sensors or the like are embedded, and capable of displaying various information thereon and receiving various operation inputs from an operating user (manipulating user).

The controller 9 is a control unit for generally controlling the MFP 10. The controller 9 is a computer system which is embedded in the MFP 10 and comprises a CPU, various semiconductor memories (RAM and ROM), and the like. The controller 9 causes the CPU to execute a predetermined software program (hereinafter, also referred to simply as a program) stored in the ROM (e.g., EEPROM (registered trademark)), to thereby implement various processing parts. Further, the program (in more detail, a group of program modules) may be installed in the MFP 10 via the network. Alternatively, the program may be recorded in one of various portable recording media (in other words, various non-transitory computer-readable recording media), such as a USB memory or the like, and read out from the recording medium to be installed in the MFP 10.

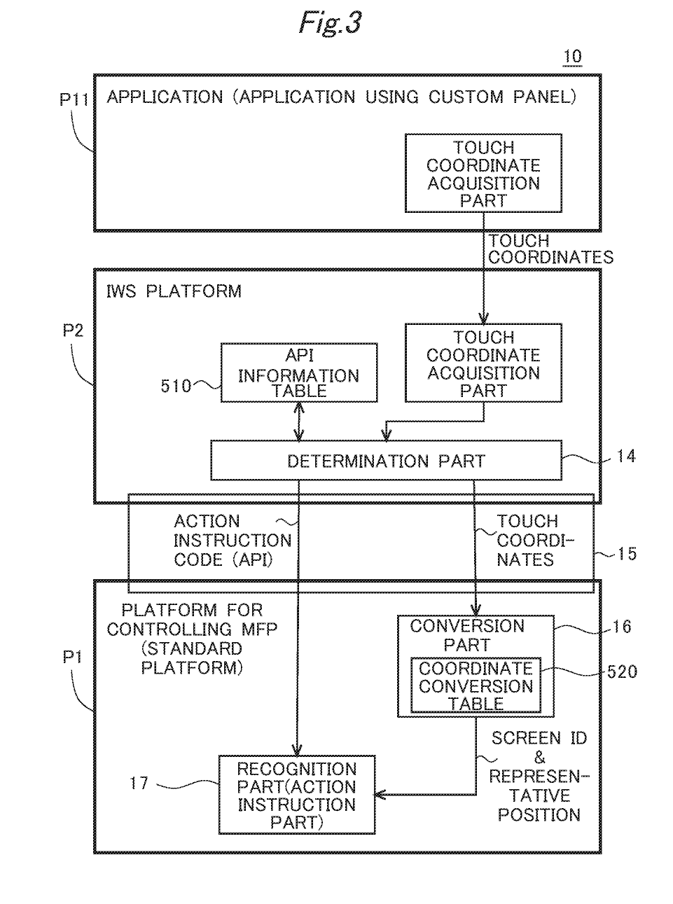

FIG. 3 is a diagram showing a software structure and the like in the MFP 10.

As shown in FIG. 3, the MFP 10 has two different platforms P1 and P2 which are constructed in the MFP 10. Specifically, the MFP 10 has a platform for controlling the MFP (also referred to as a “standard platform”) P1 and an IWS (Internal Web Server) platform P2.

The platform for controlling the MFP (standard platform) P1 is a platform for controlling various operations of the MFP.

The IWS platform P2 is a platform capable of transmitting/receiving information between a web server (internal server) provided inside the MFP and a web browser provided inside the MFP. The web browser displayed on the touch panel 25 transmits, to the web server, various information (input information) (information of a touch operation position, and the like) received by an input operation to the touch panel 25, and the web server performs a process (a setting process, a screen changing process, and the like) based on the various information.

Further, the platforms P1 and P2 are each constructed as a set of program modules.

Furthermore, on the two platforms P1 and P2, user interfaces UI1 and UI2 individually operates, respectively. The user interfaces UI1 and UI2 are each a user interface implemented by software.

On the platform (standard platform) P1 for controlling the MFP, a first user interface (also referred to as a “standard user interface”) UI1 operates. In the standard user interface UI1, various operation screens (MFP panel screens) which are generated for the MFP 10 in advance are (selectively) displayed.

On the other hand, on the IWS platform P2, a second user interface (IWS user interface) UI2 operates. The IWS user interface UI2 has a customized screen (also referred to as a “my panel screen”). In other words, in the IWS user interface UI2, at least one display element (also referred to as an “operation element (manipulation element)”) selected among a plurality of display elements (e.g., display buttons and the like) in the first user interface UI1 can be arranged in accordance with user's preference (customizably arranged). In the IWS user interface UI2, a customized screen for each user is displayed on the touch panel 25, and an operation is performed to the MFP 10 by using the customized screen.

Further, in the UI builder performed by the client computer 70, the customized screen and screen data and the like of the customized screen are generated in accordance with the operation of the user and an application P11 (also referred to as an application using customized screen) for the MFP 10 is prepared. Then, the application P11 using the customized screen, the screen data of the customized screen, an API information table 510 (described later), a coordinate conversion table 520 (described later), and the like are transmitted from the client computer 70 (UI builder) to the MFP 10. When the application using the customized screen is performed in the MFP 10 by using the screen data, the data tables 510 and 520, and the like, and so on, the user can use the customized screen in the MFP 10.

Specifically, as shown in FIG. 2, the controller 9 executes the above-described platforms P1 and P2 and the application P11, to thereby implement various processing parts including an input control part 11, a display control part 12, a communication control part 13, a determination part 14, an information transmitting/receiving part (information transfer part) 15, a conversion part 16, and a recognition part 17.

The input control part 11 is a control part for controlling an operation inputting operation to the operation input part 6a (the touch panel 25 or the like). For example, the input control part 11 controls an operation for receiving an operation input (a specification input from the user, or the like) to an operation screen displayed on the touch panel 25.

The display control part 12 is a processing part for controlling a display operation on the display part 6b (the touch panel 25 or the like). The display control part 12 displays the operation screen or the like for operating the MFP 10 on the touch panel 25.

The communication control part 13 is a processing part for controlling a communication operation with other apparatus(es) (the client computer 70 or/and the like) in cooperation with the communication part 4 and the like. The communication control part 13 has a transmission control part for controlling transmission of various data and a reception control part for controlling reception of various data.

When a user operation (user manipulation) is performed in the customized screen of the IWS user interface U12, the determination part 14 serves as a processing part for determining information (hereinafter, also referred to as “recognition information”) to be used for recognizing an instruction content given by the user operation. It can be expressed that the determination part 14 is a processing part for determining information (hereinafter, also referred to as “transmission/reception target information”) to be transferred to the standard platform P1 when the user operation is performed in the IWS user interface U12. The recognition information (or the transmission/reception target information) is determined, for example, among two types of information (described later). One of the two types of information is information on an operation position (manipulation position) of the user operation (e.g., operation position information indicating the operation position (coordinate information of a touch position, or the like)). Further, the other type of information is action instruction information which is information instructing an action of the MFP 10, based on the user operation (e.g., an action instruction code (in more detail, an action instruction code formed by using an API)).

The information transmitting/receiving part 15 is a processing part for transferring the information determined by the determination part 14 from the IWS platform P2 to the standard platform P1. In other words, the information transmitting/receiving part 15 is a processing part for transferring the recognition information (in more detail, the information to be used for causing the standard user interface UI1 to recognize the instruction content given by the user operation in the IWS user interface UI2) to the standard platform P1.

The conversion part 16 is a processing part for converting the operation position information in the IWS user interface Ui2 into operation element information of a corresponding operation screen (information of a corresponding operation element in the corresponding operation screen, or the like) in the standard user interface UI1. The operation element information obtained after the conversion includes, for example, a screen ID of the corresponding operation screen, a representative position (center position or the like) of the corresponding operation element (corresponding display element) (a display button or the like), and the like.

The recognition part 17 is a processing part for recognizing the instruction content (instruction content intended by the user) given by the user operation in the IWS user interface UI2, on the basis of the information transferred from the IWS platform P2 to the standard platform P1, or the like.

<1-3. Constitution of User Interfaces UI1 and UI2>

Next, the two types of user interfaces UI1 and UI2 will be described.

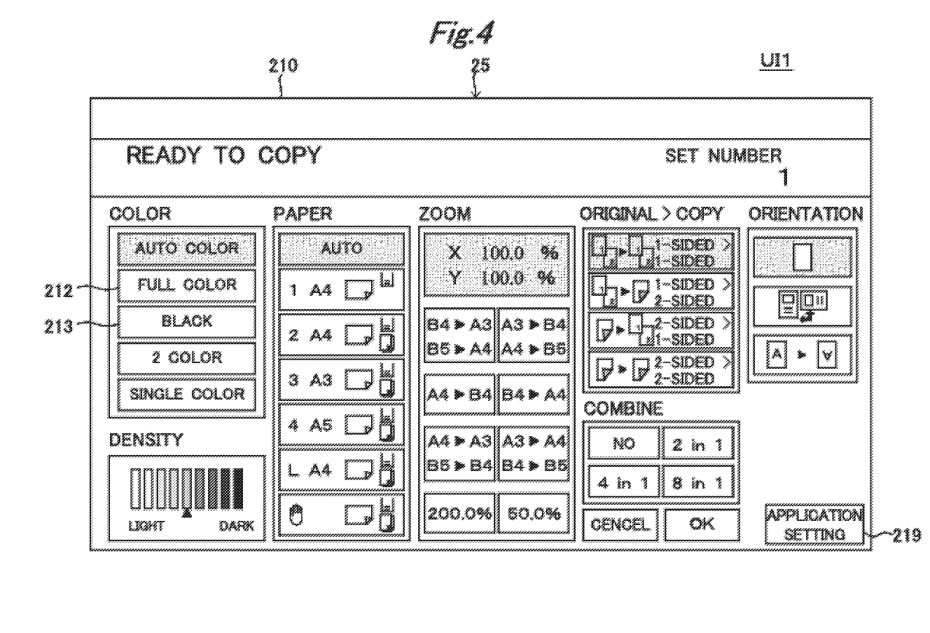

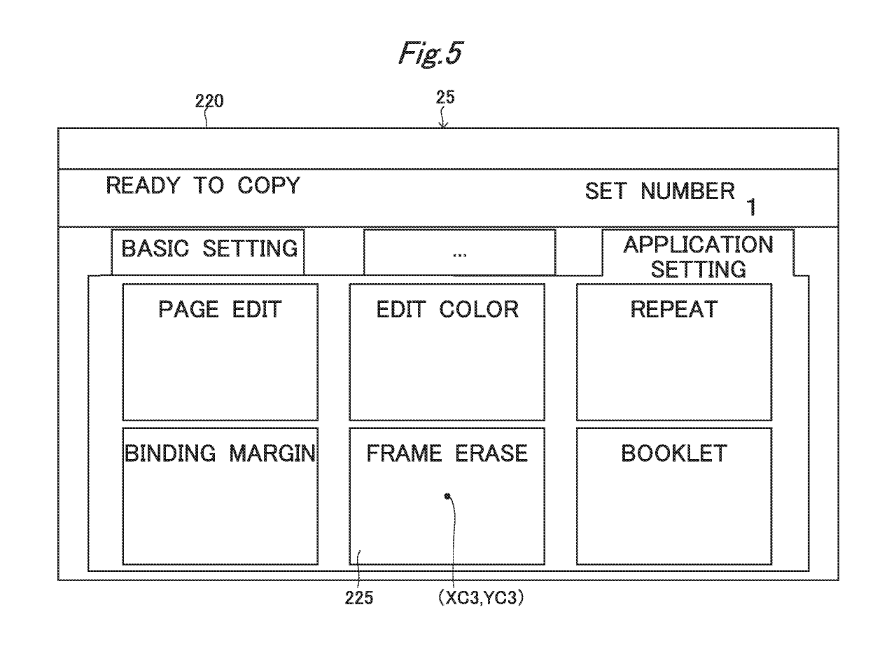

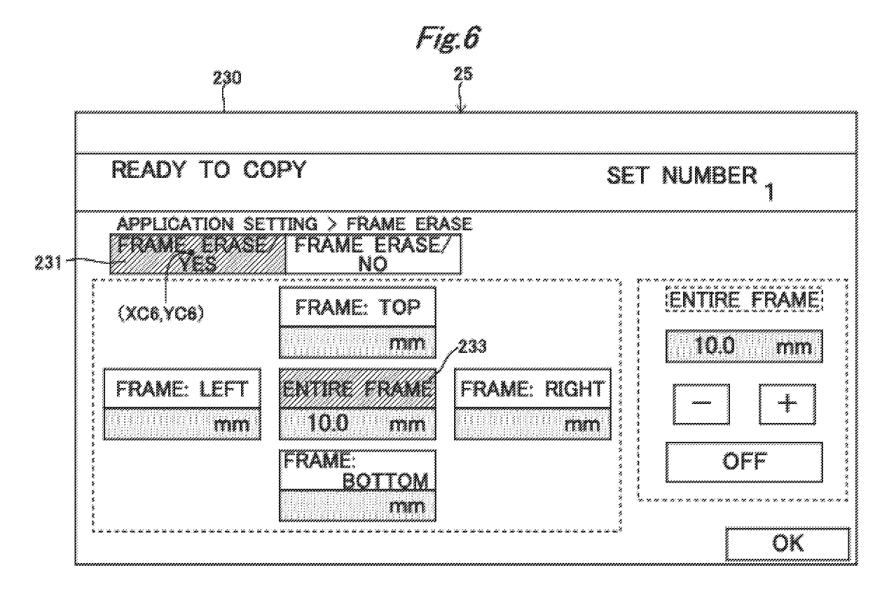

FIG. 4 is a view showing one operation screen 210 in the standard user interface UI1. FIG. 5 is a view showing another operation screen 220 in the standard user interface UI1. FIG. 6 is a view showing still another operation screen 230 in the standard user interface UI1.

FIG. 4 shows a setting screen (in more detail, a basic setting screen in a batch (collective) setting mode) 210 in the standard user interface UI1. The screen 210 shown in FIG. 4 is a screen in which settings on a relatively large number of setting items (“Color”, “Density”, “Paper”, “Zoom”, “Duplex/Combine”, and the like) can be collectively performed.

In the screen 210 of FIG. 4, a plurality of options are displayed for each of the plurality of setting items. The user can perform a setting operation for a plurality of selection items, for example, by repeating an operation of selecting a desired option among the plurality of options of each setting item, for the plurality of selection items (as necessary).

Further, when the user intends to perform an “Application Setting” process (in more detail, for example, setting of “Frame Erase”), the user presses an application-setting button 219 disposed on the lower right in the screen 210. In response to this pressing operation, the screen 220 of FIG. 5 is displayed on the touch panel 25. Then, when the user further presses a frame-erase button 225 in the screen 220, in response to this pressing operation, the screen 230 of FIG. 6 is displayed. The user can perform a setting process on “Frame Erase” by using the screen 230.

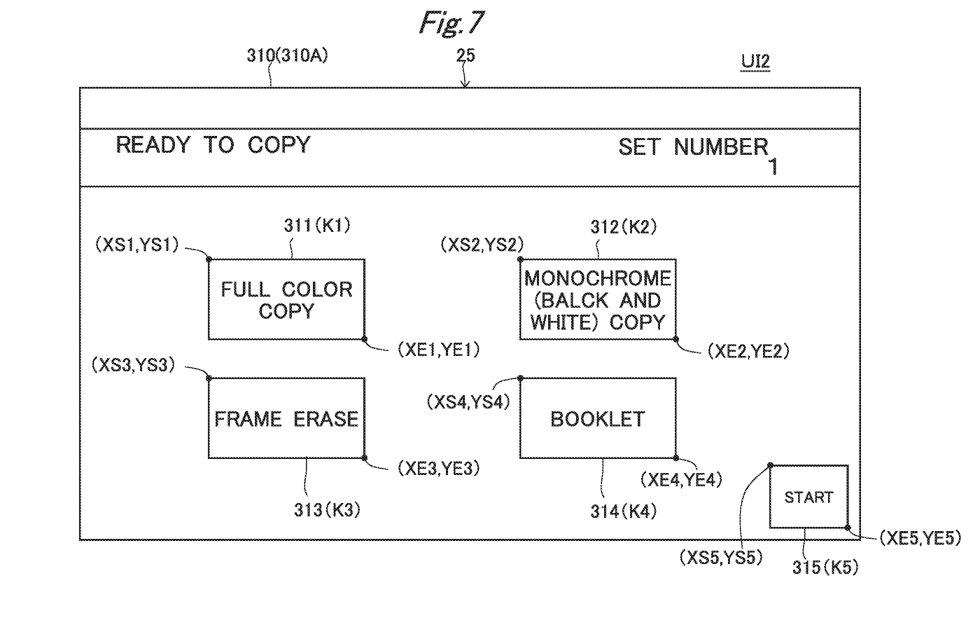

On the other hand, FIG. 7 shows a setting screen (in more detail, a customized screen) 310 in the IWS user interface UI2. The customized screen 310 of FIG. 7 comprises totally five buttons, i.e., a “Full Color Copy” button 311, a “Monochrome Copy” button 312, a “Frame Erase” button 313, a “Booklet” button 314, and a start button 315.

In this customized screen 310, the user can arrange, for example, buttons which he uses with relatively high frequency. When the user presses the frame-erase button 313, for example, the screen 230 can be immediately displayed on the touch panel 25.

If the same setting process is performed by using the above-described standard user interface UI1, it is necessary for the user to take a procedure of looking for the application-setting button 219 in the screen 210 (FIG. 4) to press it and then looking for the frame-erase button 225 in the subsequently-displayed screen 220 (FIG. 5) to press it. In other words, the user needs to perform a relatively complicate operation of looking for the target setting items in a plurality of menu screens in a hierarchical structure to press the buttons therefor.

In contrast to the above case, when the customized screen 310 (FIG. 7) is used, by pressing the desired button 225 in the customized screen 310, the desired screen 230 can be displayed. In other words, it is possible to relatively easily find the desired setting item and perform the setting operation on the desired setting item with relatively little labor.

Actually, this customized screen 310 is a screen operating on the IWS user interface UI2. As described earlier, there are some buttons (functions) which cannot be used in the conventional IWS user interface. As to the “Frame Erase” button (function), for example, no API (interface between the two platforms) corresponding to the button (in detail, the function assigned to the button) is prepared, and therefore the “Frame Erase” button cannot be used in the conventional IWS user interface.

On the other hand, in the present preferred embodiment, when the button for which no corresponding API (interface between the platforms P1 and P2) is prepared (the button for which the corresponding API is undefined) is pressed, touch coordinates in the customized screen 310 are transferred from the IWS platform P2 to the standard platform P1. Then, the standard platform P1 uses the coordinate conversion table 520 to convert the touch coordinates in the IWS user interface UI2 into the operation element information in the standard user interface UI1. As described above, the operation element information obtained after the conversion includes, for example, the screen ID of the corresponding operation screen, the representative position (center position or the like) of the corresponding display element (the display button or the like), and the like. Then, on the basis of the operation element information obtained after the conversion, the standard platform P1 understands (recognizes) the instruction content given by the user operation in the IWS user interface UI2. With this method, it is not necessary to additionally define the API, and the standard user interface UI1 can understand the instruction content of the user instruction. Hereinafter, such an aspect of the present invention will be described in detail.

<1-4. Operation>

<Generation of Customized Screen by UI Builder of Computer 70, Etc.>

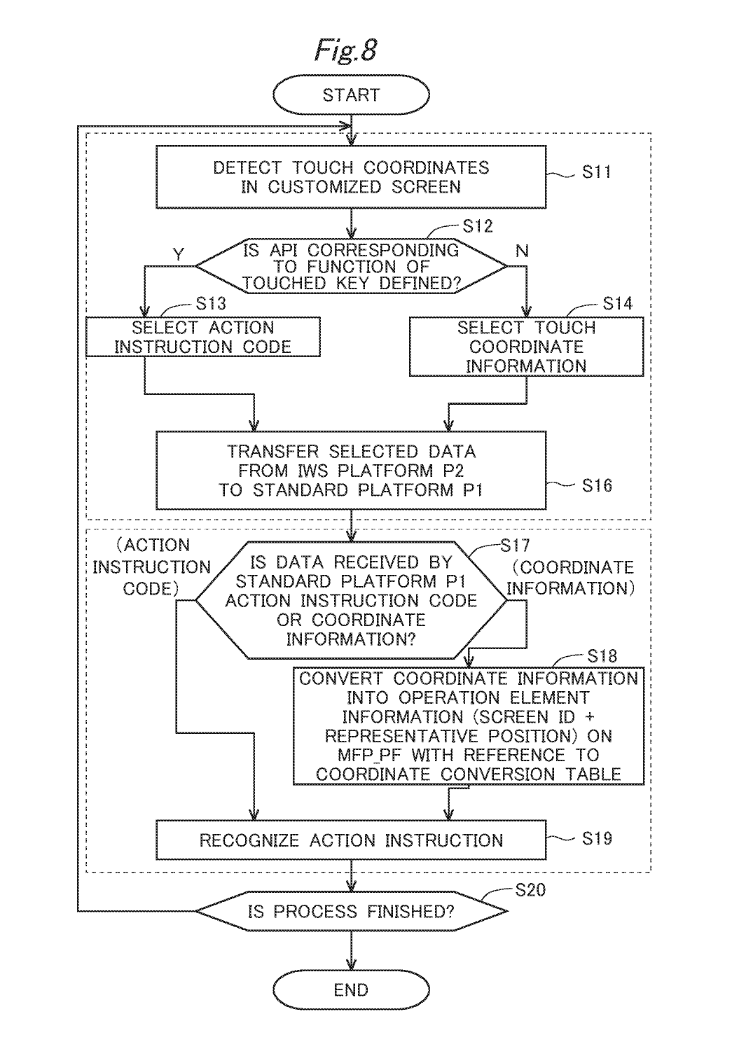

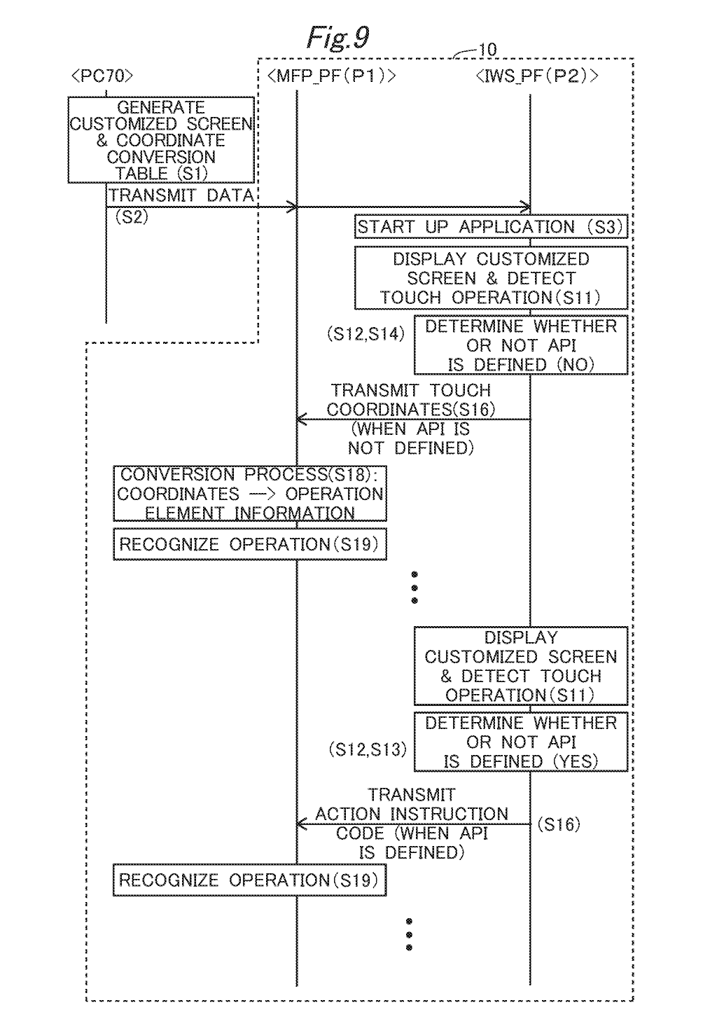

FIG. 8 is a flowchart showing an operation of the MFP 10 in accordance with the present preferred embodiment, and FIG. 9 is a sequence diagram showing an operation of the present system 1. In FIG. 9 and the like, the standard platform P1 of the MFP 10 is also represented as “MFP_PF” and the IWS platform P2 is also represented as “IWS_PF”.

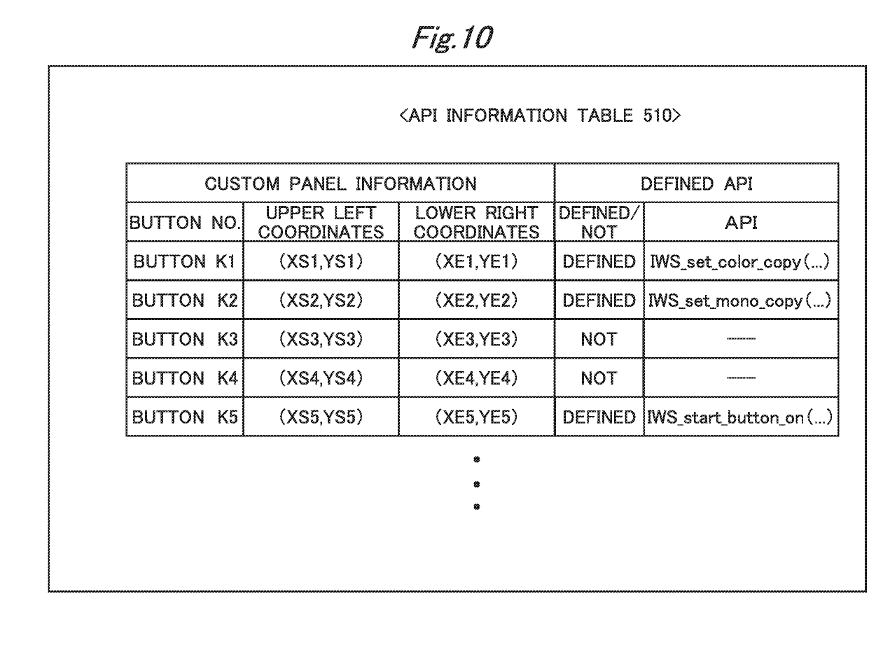

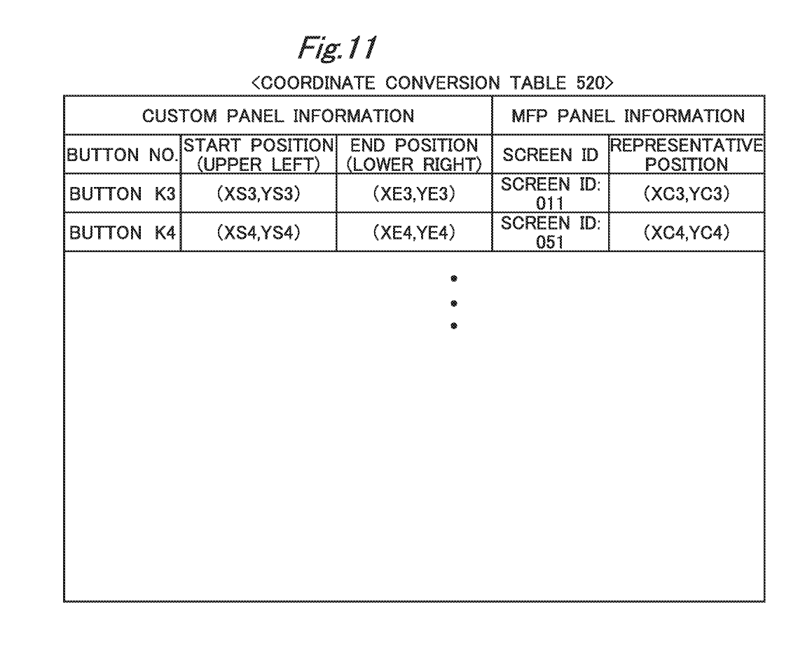

As shown in FIG. 9, first, the client computer 70 performs the UI builder. In the UI builder, the customized screen 310 (FIG. 7) is generated in accordance with the user operation and various data on the customized screen 310 (for example, the screen data of the customized screen 310, the API information table 510 (FIG. 10), the coordinate conversion table 520 (FIG. 11), and the like) are generated (Step S1 (see the uppermost stage of FIG. 9)). The generated various data, together with the application P11 using the customized screen for the MFP 10, are transmitted from the client computer 70 to the MFP 10 (Step S2 (see FIG. 9)). When the MFP 10 receives the various data and the like from the client computer 70, the MFP 10 stores the various data and the like in the storage part 5.

FIG. 10 is a view showing an exemplary API information table 510, and FIG. 11 is a view showing an exemplary coordinate conversion table 520.

It is assumed herein that respective corresponding APIs for some buttons 311 (K1), 312 (K2), and 315 (K5) among the five software buttons (software keys) 311 to 315 arranged in the customized screen 310 (FIG. 7) are defined. Further, it is assumed that respective corresponding APIs for the remaining buttons 313 (K3) and 314 (K4) are not defined.

In the UI builder, for example, in accordance with the user operation, respective positions (arrangement positions) of the buttons in the customized screen 310 are specified. Further, the user of the UI builder specifies buttons to be associated with the buttons in the customized screen 310, among a plurality of buttons in a plurality of operation screens of the standard user interface UI1. For example, the user specifies a button 212 in the screen 210 (FIG. 4) as the button to be associated with the button 311. Further, the user specifies a button 213 in the screen 210 (FIG. 4) as the button to be associated with the button 312. Similarly, the user specifies the button 225 in the screen 220 (FIG. 5) as the button to be associated with the button 313. The user also specifies buttons to be associated with the other buttons 314 and 315 as appropriate.

Then, the UI builder determines whether the APIs corresponding to the specification target buttons (212, 213, 225, and the like) (in other words, the specification source buttons (311, 312, 313, and the like)) are defined or not. Specifically, the UI builder determines whether or not the instruction content given by the button operation on the specification target (in other words, the button operation on the specification source) is corresponding to a defined API. Then, the UI builder registers (stores) the content based on the determination result into the API information table 510 (see FIG. 10) and the coordinate conversion table 520 (see FIG. 11).

In more detail, as shown in FIG. 10, in the API information table 510, stored are pieces of arrangement information (for example, an ID (button No.) of each button, and upper left coordinates and lower right coordinates of each button having a rectangular shape (in other words, information on a display position of each button)) of the buttons 311 to 315 (K1 to K5) in the customized screen 310.

Further, in the API information table 510, information (i.e., “Defined/Not”) indicating whether the API (corresponding API) corresponding to each button is defined or not is also stored. Further, when the corresponding API is defined, the corresponding API itself is associated with the button and stored therein.

In other words, in the API information table 510, it is defined whether or not the user operation on each button is assigned to any action instruction code in advance. Further, when the user operation on a button is assigned to an action instruction code in advance, the action instruction code (corresponding API) to which the user operation is assigned is also associated with the button and stored therein. Specifically, in the API information table 510, defined is a correspondence between the display position (arrangement position) of each of some display elements (buttons and the like) in the IWS user interface UI2 and the action instruction code (action instruction command) corresponding to the display element.

As to the button 311, for example, the information indicating that the corresponding API is present (“Defined”) and the corresponding API itself (IWS_set_color_copy), being associated with the arrangement information (the upper left coordinates (XS1, YS1) and the lower right coordinates (XE1, YE1)) of the button 311 (K1), are registered.

Further, as to the button 312, the information indicating that the corresponding API is present (“Defined”) and the corresponding API itself (IWS_set_mono_copy), being associated with the arrangement information (the upper left coordinates (XS2, YS2) and the lower right coordinates (XE2, YE2)) of the button 312 (K2), are registered.

Furthermore, as to the button (start button) 315, the information indicating that the corresponding API is present (“Defined”) and the corresponding API itself (IWS_start_button_on), being associated with the arrangement information (the upper left coordinates (XS5, YS5) and the lower right coordinates (XE5, YE5)) of the button 315 (K5), are registered.

On the other hand, as to the button 313, the information indicating that the corresponding API is not present (“Not”), being associated with the arrangement information (the upper left coordinates (XS3, YS3) and the lower right coordinates (XE3, YE3)) of the button 313 (K3), is registered.

Similarly, as to the button 314, the information indicating that the corresponding API is not present (“Not”), being associated with the arrangement information (the upper left coordinates (XS4, YS4) and the lower right coordinates (XE4, YE4)) of the button 314 (K4), is registered.

Further, as shown in FIG. 11, in the coordinate conversion table 520, registered (stored) are pieces of coordinate conversion information only on the buttons (herein, the buttons 313 (K3) and 314 (K4)) for which the corresponding API is not defined.

Specifically, as to the button 313 (K3), for example, the operation element information of the corresponding operation screen in the standard user interface UI1, being associated with the arrangement information (the upper left coordinates (XS3, YS3) and the lower right coordinates (XE3, YE3)) of the button 313 (K3) in the customized screen 310, is stored (defined). In more detail, the information of the button 225 in the standard user interface UI1, which is corresponding to the instruction content given by the button 313 in the customized screen 310, is stored in the coordinate conversion table 520. More specifically, the screen ID “011” (screen identification information) of the screen 220 having the button 225 (the screen 220 to which the button 225 belongs) and the representative position (herein, the center position (XC3, YC3) (see FIG. 5)) of the button 225 are stored as the operation element information of the corresponding operation screen 220 in the standard user interface UI1.

As to the button 314, the same contents are stored.

Further, as described later, this coordinate conversion table 520 serves as a conversion table used for converting the operation position information (coordinate position or the like) in the IWS user interface UI2 into the operation element information (the screen ID of the screen including the corresponding button and the representative position coordinates of the corresponding button) of the corresponding operation screen in the standard user interface UI1.

The UI builder generates these information (the API information table 510, the coordinate conversion table 520, and the like) and transmits the information and the application P11 using the customized screen to the MFP 10 (Step S2).

When the MFP 10 receives the application P11 using the customized screen, the API information table 510 (FIG. 10), the coordinate conversion table 520, and the like from the client computer 70 (Step S2), the MFP 10 stores the application P11 using the customized screen, the API information table 510 (FIG. 10), the coordinate conversion table 520, and the like into the storage part 5.

Further, after that, in a state where the application P11 using the customized screen is started up (described later), the coordinate conversion table 520 (FIG. 11) is used by the standard platform P1 and the API information table 510 (FIG. 10) is used by the IWS platform P2 (also see FIG. 3).

<Operation in MFP 10>

In the MFP 10, at a timing (in accordance with a predetermined operation by the user, immediately after the power-on, or the like), the IWS platform P2 is started up by the active standard platform P1. Further, after that, in accordance with the user operation or the like, the application P11 using the customized screen is started up on the IWS platform P2 (Step S3 (FIG. 9)).

After the application P11 using the customized screen is started up, the process operation shown in FIG. 8 is performed.

First, in the IWS platform P2, the customized screen 310 which is generated by the UI builder in advance is displayed on the touch panel 25 through the application P11 using the customized screen (in more detail, the web browser thereof). Then, when the user operation is performed on the customized screen 310, the user operation is detected by the touch panel 25 and the detailed information is transmitted from the application P11 using the customized screen to the IWS platform P2 (Step S11). Specifically, the IWS platform P2 acquires the information (operation position information) of the operation position of the user operation in the customized screen 310 (for example, the coordinate information of the touch position (press position) of the touch operation (pressing operation)).

Next, in the IWS platform P2, the process of Steps S11 to S16 (see FIG. 8) is performed. Specifically, first, with reference to the API information table 510, IWS platform P2 determines which of the two types of information, i.e., the information (operation position information) on the operation position of the user operation and the action instruction information based on the user operation, should be transferred to the standard platform P1 of the standard user interface UI1 (Step S12). In more detail, in accordance with whether or not the user operation is assigned to any action instruction code in advance, it is determined which of the two types of information should be transferred. Further, whether or not the user operation is assigned to any action instruction code in advance is determined on the basis of the API information table 510 and the operation position of the user operation in the customized screen 310. Next, in accordance with the determination content of Step S12, the IWS platform P2 performs the operation of Step S13 or Step S14. Further, the IWS platform P2 performs the operation of Step S16.

Specifically, when the IWS platform P2 determines, with reference to the API information table 510, that the instruction content given by the user operation in the IWS user interface UI2 (Step S11) is assigned to specific action instruction information in advance, the IWS platform P2 determines that the specific action instruction information should be transferred to the standard platform P1 (Step S12). In other words, the specific action instruction information is determined as the data (recognition information) to be transferred. In this case, the process goes to Step S13, and the specific action instruction information (in more detail, the specific action instruction code (formed, for example, by using a specific API designed for a specific action instruction)) is selected as the data to be transferred. Then, the process goes to Step S16. In Step S16, the specific action instruction information is transferred from the IWS platform P2 to the standard platform P1. In other words, the instruction content given by the user operation is directly transferred to the standard platform P1 in a form of “action instruction information”.

When a pressing operation (touch operation) on the full-color copy button 311 (K1) is performed in the customized screen 310, for example, the following operation is performed. First, the IWS platform P2 determines, with reference to the API information table 510 (FIG. 10) and the like, that the operation position (touch position (Xt, Yt)) of the user operation (Step S11) has coordinates inside the button 311 (K1), in other words, that the user operation is performed on the button 311 (K1) (Step S12). Further, when the IWS platform P2 also determines, with reference to the API information table 510 (FIG. 10), that a defined API is assigned to the button 311 (K1), the IWS platform P2 determines that the instruction content given by the user operation is assigned to a specific API (IWS_set_color_copy) in advance (in other words, an API corresponding to the user operation is defined) (Step S12). When such a determination is made, it is determined that the specific action instruction information should be transferred to the standard platform P1 (Step S12). In other words, the specific action instruction information (specific API) is determined as the data (recognition information) to be transferred. Then, the action instruction information is transferred from the IWS platform P2 to the standard platform P1 by using the specific action instruction information (specific API) (Steps S13 and S16).

As another case, also when a pressing operation (touch operation) on the start button 315 (K5) is performed in the customized screen 310, the same operation is performed. First, the IWS platform P2 determines, with reference to the API information table 510 (FIG. 10), that the instruction content given by the user operation (Step S11) is assigned to a specific API (IWS_start_button_on) in advance (Step S12). Then, the specific action instruction information (specific API) is determined as the data (recognition information) to be transferred (Step S12), and the action instruction information (start instruction information) is transferred from the IWS platform P2 to the standard platform P1 by using the specific API (Steps S13 and S16).

On the other hand, when the user operation in the IWS user interface UI2 is not assigned to any action instruction code in advance, the IWS platform P2 determines that the information on the operation position of the user operation should be transferred to the standard platform P1 (Step S12). In other words, the information on the operation position of the user operation is determined as the data (recognition information) to be transferred. Then, the information on the operation position of the user operation (herein, the operation position information (in more detail, the coordinate information of touch information)) is selected as the data to be transferred (Step S14), and this information is transferred from the IWS platform P2 to the standard platform P1 (Step S16). In other words, the instruction content given by the user operation is, so to say, indirectly transferred from the IWS platform P2 to the standard platform P1 in a form of “information on the operation position of the user operation (herein, operation position information)”.

When a pressing operation (touch operation) on the frame-erase button 313 (K3) is performed in the customized screen 310, for example, the following operation is performed. First, the IWS platform P2 determines, with reference to the API information table 510 (FIG. 10) and the like, that the touch position (Xt, Yt) of the user operation (Step S11) has coordinates inside the button 313 (K3), in other words, the user operation is performed on the button 313 (K3). Further, with reference to the API information table 510 (FIG. 10), also on the basis of a fact that no defined API is assigned to the button 313 (K3), the IWS platform P2 determines that the instruction content given by the user operation is not assigned to any API (Step S12). In other words, it is determined that an API corresponding to the user operation is not defined yet. When such a determination is made, as the data (recognition information) to be transferred, the information on the operation position of the user operation (in more detail, the coordinate information of the touch position) is determined (Step S12). Then, this information (recognition information) is transferred from the IWS platform P2 to the standard platform P1 (Steps S14 and S16).

Next, in the standard platform P1, the process of Steps S17 to S19 (see FIG. 8) is performed. Specifically, the standard platform P1 recognizes the instruction content given by the user operation in the IWS user interface UI2 on the basis of the information (recognition information) transferred from the IWS platform P2 to the standard platform P1, and performs the process in accordance with the instruction content (Steps S17 to S19).

In more detail, when the information transferred from the IWS platform P2 is the “action instruction information”, the process goes from Step S17 to Step S19, and the standard platform P1 recognizes the instruction content given by the user operation (Step S11) on the basis of the action instruction information (also see the lower portion of FIG. 9).

When the action instruction information using the specific API (“IWS_set_color_copy”) is transferred from the IWS platform P2 to the standard platform P1, for example, the following operation is performed. Specifically, the standard platform P1 recognizes, on the basis of the specific API, that the instruction content given by the user operation (Step S11) indicates the setting of “Full Color Copy” (the instruction content indicates that the mode relating to “Color” of the copy function should be set to the “Full Color Copy” mode). Then, on the basis of the instruction content, the standard platform P1 performs a “Full Color Copy” setting process (a process of setting the mode relating to “Color” of the copy function to the “Full Color Copy” mode).

As another case, when the action instruction information (start instruction information) using the specific API (“IWS_start_button_on”) is transferred from the IWS platform P2 to the standard platform P1, the following operation is performed. Specifically, the standard platform P1 recognizes, on the basis of the specific API (specific action instruction code), that the instruction content given by the user operation (Step S11) indicates the “start instruction”. Then, on the basis of the instruction content, the standard platform P1 performs the process (process of starting a copy operation) based on the “start instruction”.

On the other hand, when the information transferred from the IWS platform P2 is the “the information on the operation position (operation position information)”, the process goes to Step S18 (also see the substantially center portion of FIG. 9). In Step S18, with reference to the coordinate conversion table 520 (FIG. 11), the standard platform P1 converts the operation position information (touch coordinates) in the IWS user interface UI2 into the operation element information of the corresponding operation screen in the standard user interface UI1. Then, on the basis of the operation element information obtained after the conversation of the operation position information transferred from the IWS platform P2, the standard platform P1 recognizes the instruction content given by the user operation (Step S11).

When the coordinates (Xt, Yt) of a position inside the button 313 (K3) in the customized screen 310 is transferred as the operation position information (touch coordinates), for example, the following operation is performed. Specifically, on the basis of the coordinate conversion table 520 (FIG. 11), the standard platform P1 converts the operation position information (touch coordinate position (Xt, Yt)) into the operation element information on the corresponding operation screen in the standard user interface UI1.

More specifically, the standard platform P1 determines, with reference to the coordinate conversion table 520 (FIG. 11) and the like, that the operation position (the touch position (Xt, Yt)) of the user operation (Step S11) has coordinates inside the button 313 (K3), in other words, that the user operation is performed on the button 313 (K3). Further, with reference to the coordinate conversion table 520 (FIG. 11), the standard platform P1 acquires the information (operation element information) of the corresponding display element (in the standard user interface UI1) corresponding to the button 313 (K3) in the IWS user interface UI2. Then, the standard platform P1 converts the touch coordinate position (Xt, Yt) into the operation element information (information including the screen ID “011” of the corresponding operation screen and the representative coordinate position “(XC3, YC3)” of the corresponding button in the corresponding operation screen having the screen ID in the standard user interface UI1).

In other words, the operation position information (Xt, Yt) of the user operation on a specific display element (for example, the display button 313 in the customized screen 310) in the IWS user interface UI2 is converted into the operation element information (in more detail, information of a specific corresponding display element corresponding to the specific display element (target element of the user operation)) in the corresponding operation screen (e.g., the screen 220). The corresponding operation screen is a screen (e.g., the screen 220) including the corresponding display element (e.g., the display button 225) corresponding to the specific display element (the display button 313 or the like).

Then, on the basis of the operation element information obtained after the conversion, the standard platform P1 recognizes that the instruction content given by the user operation (Step S11) is the same as the instruction content given by the pressing operation on the position (XC3, YC3) in the screen having the screen ID “011” (the screen 220 (FIG. 5)). In other words, the standard platform P1 recognizes that the instruction content given by the user operation (Step S11) is the same as the instruction content given by the pressing operation on the “Frame Erase” button 225 in the screen 220 (FIG. 5). Further, on the basis of the instruction content, the standard platform P1 performs a process of displaying the setting screen 230 used for the “Frame Erase” setting process.

After that, when it is determined in Step S20 that the process should continue, the process goes back to Step S11, and the above-described operation (Steps S11 to S19) is repeatedly performed. On the other hand, when it is determined in Step S20 that the process should be ended, the process of FIG. 8 is ended.

As described above, in the operation of the first preferred embodiment, when the user operation is performed in (the customized screen 310 of) the IWS user interface UI2 (Step S11), it is determined which of the two types of information, i.e., the operation position information on the operation position of the user operation and the action instruction information based on the user operation, should be transferred to the standard platform P1 (Step S12). Then, in accordance with the determination result, either one of the operation position information and the action instruction information is transferred from the IWS platform P2 to the standard platform P1 (Steps S13, S14, and S16).

With this operation, it is possible to exclude any limitation due to whether or not there is an action instruction code for cooperation (API for cooperation, or the like) between the two user interfaces UI1 and UI2 and arrange relatively diverse buttons in the customized screen 310 of the IWS user interface UI2.

In more detail, when the “action instruction information” is transferred from the IWS platform P2, the standard platform P1 recognizes the instruction content given by the user operation on the basis of the action instruction information (API) (Steps S17 and S19). Therefore, when the API designed to indicate the instruction content given by the user operation is defined in advance, the instruction content is directly transmitted to the standard platform P1 by using the defined API (action instruction information). That is to say, the standard platform P1 can directly recognize the instruction content given by the user operation. In other words, the button for which the corresponding API is defined can be disposed in the customized screen 310.

On the other hand, when the “operation position information” is transferred from the IWS platform P2, by performing the conversion process using the coordinate conversion table 520, the operation position information is converted into the operation element information (the representative position of the corresponding button, the screen ID of the screen to which the corresponding button belongs, and the like) on the corresponding operation screen in the standard user interface UI1 (Steps S17 and S18). Then, the standard platform P1 recognizes the instruction content given by the user operation (Step S11) in the IWS user interface Ui2, on the basis of the operation element information obtained after the conversion. Therefore, also when the corresponding API designed to indicate the instruction content given by the user operation is not defined, the standard platform P1 can recognize the instruction content given by the user operation, on the basis of the position information of the touch operation on the button in the customized screen 310, and the like. In other words, relatively diverse buttons for each of which a corresponding API is not defined can be also arranged in the customized screen 310.

### 2. The Second Preferred Embodiment

The second preferred embodiment is a variation of the first preferred embodiment. Hereinafter, description will be made, centering on the difference between the first and second preferred embodiments.

In the above-described first preferred embodiment, when there is no defined API corresponding to the action instruction given by the user operation (in other words, when the information on the operation position of the user operation is determined as the recognition information), the operation position information of the user operation is transferred from the IWS platform P2 to the standard platform P1. Then, the standard platform P1 converts the operation position information into the operation element information on the corresponding operation screen in the standard user interface UI1 by using the coordinate conversion table 520.

On the other hand, in the second preferred embodiment, when there is no defined API corresponding to the action instruction given by the user operation, the IWS platform P2 converts the operation position information of the user operation into the operation element information on the corresponding operation screen in the standard user interface UI1 by using the coordinate conversion table 520. After that, the operation element information obtained after the conversion is transferred from the IWS platform P2 to the standard platform P1. In other words, before transferring the information from the IWS platform P2 to the standard platform P1, the IWS platform P2 performs the conversion process.

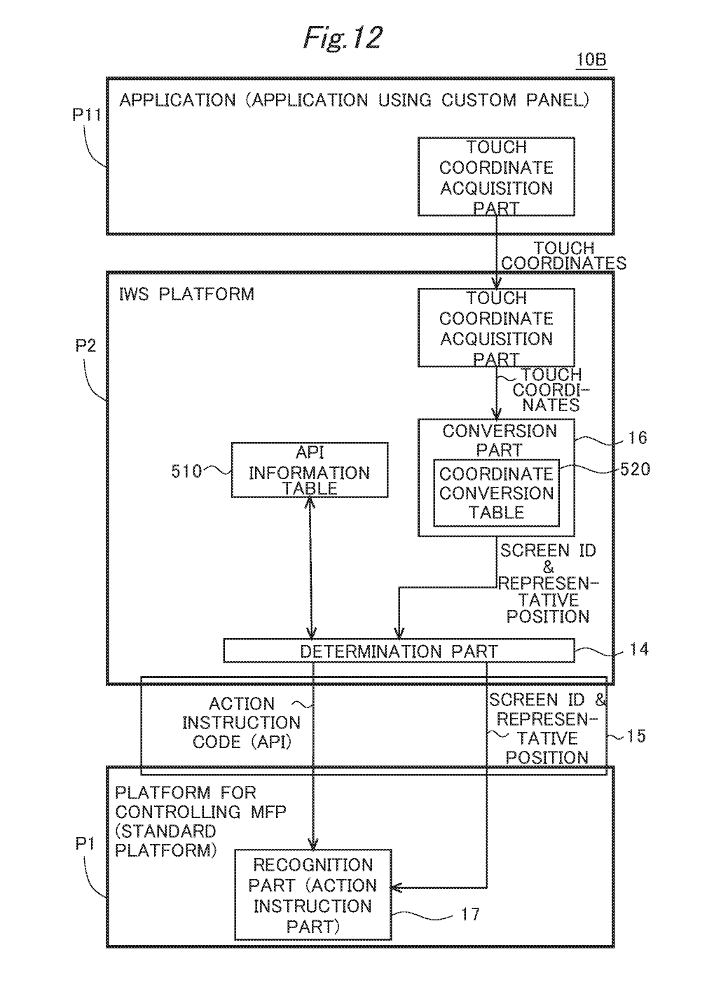

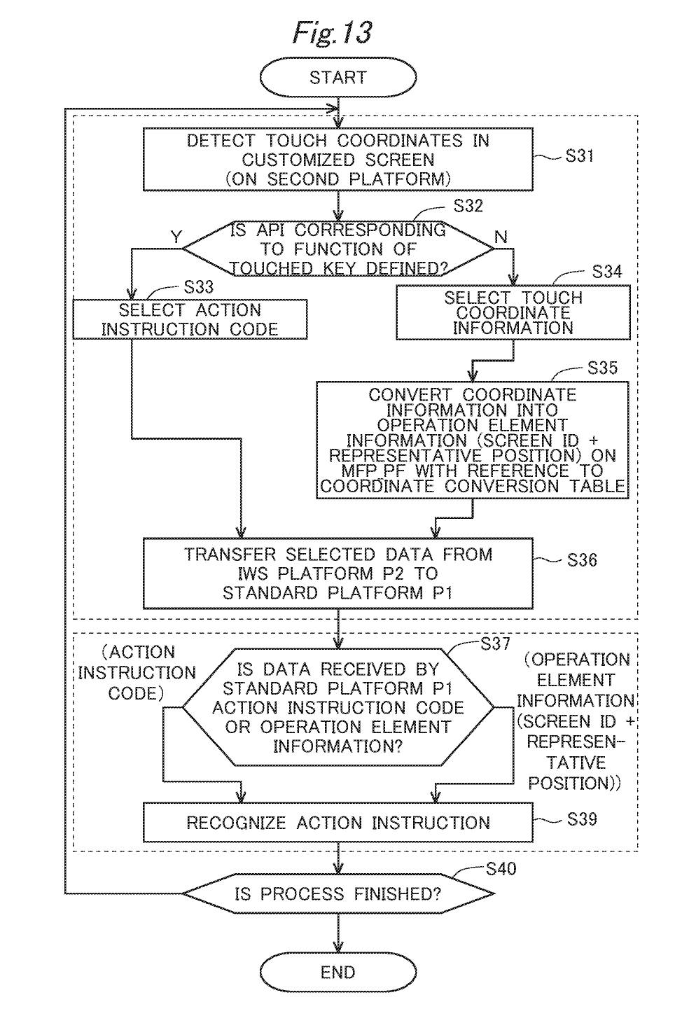

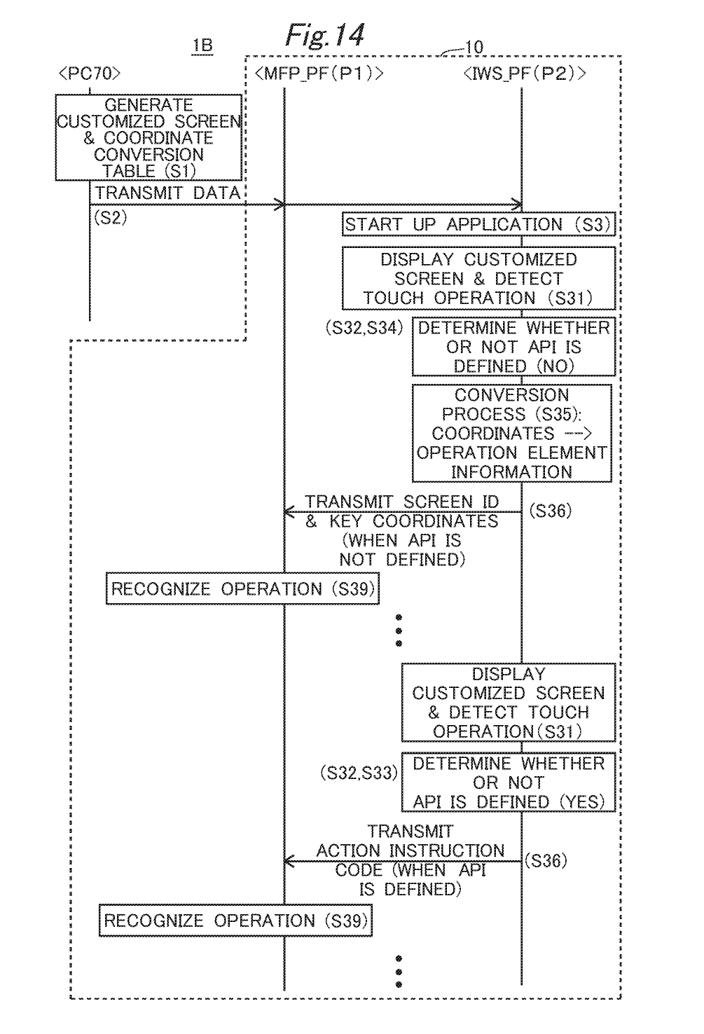

FIG. 12 is a diagram showing a software structure and the like in an MFP 10 (10B) in accordance with the second preferred embodiment. Further, FIG. 13 is a flowchart showing an operation of the MFP 10 (10B) of the second preferred embodiment, and FIG. 14 is a sequence diagram showing an operation of a system 1 (1B) of the second preferred embodiment. Hereinafter, with reference to these figures, the above-described aspect of the present invention will be described in more detail.

Also in the second preferred embodiment, first, the customized screen generation process and the like by the UI builder of the computer 70 are performed in the same manner as in the first preferred embodiment (see the top portion of FIG. 14). Then, like in the first preferred embodiment, the MFP 10 performs a process of receiving the application P11 using the customized screen, the API information table 510 (FIG. 10), the coordinate conversion table 520, and the like from the client computer 70 (Step S2), and the like.

After that, the application P11 using the customized screen is started up in the MFP 10. In the second preferred embodiment, however, in a state where the application P11 using the customized screen is started up (described later), both the coordinate conversion table 520 (FIG. 11) and the API information table 510 (FIG. 10) are used by the IWS platform P2 (also see FIG. 12).

Specifically, in the second preferred embodiment, after the application P11 using the customized screen is started up, the operation shown in FIG. 13 is performed. Steps S31 to S34 and S36 in FIG. 13 are the same as Steps S11 to S14 and S16 in FIG. 8, respectively.

In Step S32, however, the IWS platform P2 determines, with reference to the API information table 510, which of the two types of information, i.e., the information on the operation position of the user operation (in more detail, the information obtained after the conversion process using the coordinate conversion table 520) and the action instruction information based on the user operation, should be transferred to the standard platform P1 of the standard user interface UI1. In other words, the IWS platform P2 determines one of the two types of information, i.e., the action instruction information based on the user operation and the information on the operation position of the user operation, as the recognition information.

Further, in the second preferred embodiment, as shown in FIG. 13, when it is determined in Step S32 that the information on the operation position of the user operation should be transferred to the standard platform P1 (in other words, the information on the operation position of the user operation is determined as the recognition information), an operation of Step S35 is performed between Steps S34 and S36 (also see the substantially center portion of FIG. 14). In Step S35, the IWS platform P2 performs the same operation as that of Step S18. Specifically, with reference to the coordinate conversion table 520 (FIG. 11), the IWS platform P2 converts the operation position information in the IWS user interface UI2 into the operation element information of the corresponding operation screen in the standard user interface Ui1. The operation element information is thereby generated as the information on the operation position of the user operation (in other words, the recognition information).

When the coordinates (Xt, Yt) of a position inside the button 313 (K3) in the customized screen 310 is transferred as the operation position information (touch coordinates), for example, the operation position information (touch coordinate position (Xt, Yt)) is converted into the operation element information described below, on the basis of the coordinate conversion table 520 (FIG. 11).

More specifically, the IWS platform P2 determines, with reference to the coordinate conversion table 520 (FIG. 11) and the like, that the operation position (touch position (Xt, Yt)) of the user operation (Step S11) has coordinates inside the button 313 (K3), in other words, the user operation is performed on the button 313 (K3). Further, with reference to the coordinate conversion table 520 (FIG. 11), the IWS platform P2 acquires the information (operation element information) of the corresponding display element (in the standard user interface UI1) corresponding to the button 313 (K3) in the IWS user interface UI2. Then, the standard platform P1 converts the touch coordinate position (Xt, Yt) into the operation element information (information including the screen ID “011” of the corresponding operation screen in the standard user interface UI1 and the representative coordinate position “(XC3, YC3)” of the corresponding button in the screen having the screen ID).

When it is determined in Step S32 that the information on the operation position of the user operation should be transferred to the standard platform P1, in next Step S36, the IWS platform P2 transfers the information on the operation position of the user operation (in more detail, the information obtained after the conversion (the above-described operation element information)) to the standard platform P1 (also see the substantially center portion of FIG. 14).

On the other hand, when it is determined in Step S32 that the action instruction information based on the user operation should be transferred to the standard platform P1, in Step S36, the IWS platform P2 transfers the action instruction information (action instruction code) to the standard platform P1, like in Step S16 (also see the lower portion of FIG. 14).

After the above-described process of Steps S31 to S36 is performed mainly by the IWS platform P2, the standard platform P1 performs a process of Steps S37 to S39.

Specifically, first, the standard platform P1 recognizes the instruction content given by the user operation in the IWS user interface UI2 and performs the process in accordance with the instruction content, on the basis of the information transferred from the IWS platform P2 (Steps S37 to S39).

In more detail, when the information transferred from the IWS platform P2 is the “action instruction information”, the process goes from Step S37 to S39, the same process as the process (Steps S17 and S19) in the first preferred embodiment is performed. Specifically, the standard platform P1 recognizes the instruction content given by the user operation (Step S31) on the basis of the action instruction information.

On the other hand, when the information transferred from the IWS platform P2 is the information on the operation position of the user operation (in more detail, the screen ID of the corresponding screen and the representative position information of the corresponding button in the screen) (the operation element information obtained after the conversion using the coordinate conversion table 520), the process goes to Step S39. In this case, in Step S39, the standard platform P1 recognizes the instruction content given by the user operation (Step S31) on the basis of the operation element information obtained after the conversion, which is transferred from the IWS platform P2.

When the coordinates (Xt, Yt,) of the touch position inside the button 313 (K3) in the customized screen 310 is converted into the operation element information including the second “011” of the corresponding operation screen in the standard user interface UI1 and the representative coordinate position information “(XC3, YC3)” of the corresponding button in the screen having the screen ID in Step S35 and then the operation element information is transferred from the IWS platform P2 to the standard platform P1 in Step S36, for example, the following operation is further performed. Specifically, the standard platform P1 recognizes, on the basis of the operation element information, that the instruction content given by the user operation (Step S31) is the same as the instruction content given by the pressing operation on the position (XC3, YC3) in the screen having the screen ID “011” (the screen 220 (FIG. 5)). In other words, the standard platform P1 recognizes that the instruction content of the user operation is the same as the instruction content given by the pressing operation on the “Frame Erase” button 225 in the screen 220 (FIG. 5). Then, the standard platform P1 performs a process of displaying the setting screen 230 for the “Frame Erase” setting process on the basis of the instruction content.

After that, when it is determined in Step S40 that the process should continue, the process goes back to Step S31, and the above-described operation (Steps S31 to S39) is repeatedly performed. On the other hand, when it is determined in Step S40 that the process should be ended, the process of FIG. 13 is ended.

As described above, in the operation of the second preferred embodiment, when the user operation is performed in (the customized screen 310 of) the IWS user interface UI2 (Step S31), first, it is determined which of the two types of information, i.e., the operation element information on the operation position of the user operation and the action instruction information based on the user operation, should be transferred to the standard platform P1 (Step S32). When it is determined that the “operation element information” should be transferred to the standard platform P1, by performing the conversion process using the coordinate conversion table 520, the operation position information of the user operation in the IWS user interface UI2 is converted into the operation element information (the screen ID, the representative position of the corresponding button, and the like) on the corresponding operation screen in the standard user interface UI1 (Steps S34 and S35). After that, in accordance with the determination result in Step S32, either one of the operation element information and the action instruction information is transferred from the IWS platform P2 to the standard platform P1 (Steps S33, S34 to S36).

With this operation, it is possible to exclude any limitation due to whether or not there is an action instruction code for cooperation (API for cooperation, or the like) between the two user interfaces UI1 and UI2 and arrange relatively diverse buttons in the customized screen 310 of the IWS user interface UI2.

In more detail, when the “action instruction information” is transferred from the IWS platform P2, the standard platform P1 recognizes the instruction content given by the user operation on the basis of the action instruction information (API) (Steps S37 and S39). Therefore, when the API designed to indicate the instruction content given by the user operation is defined in advance, the instruction content is directly transmitted to the standard platform P1 by using the defined API (action instruction information). That is to say, the standard platform P1 can directly recognize the instruction content given by the user operation. In other words, the button for which the corresponding API is defined can be disposed in the customized screen 310.

On the other hand, when the “operation element information (after the conversion)” is transferred from the IWS platform P2, the standard platform P1 recognizes the instruction content given by the user operation (Step S31) in the IWS user interface Ui2, on the basis of the operation element information obtained after the conversion. Therefore, also when the corresponding API designed to indicate the instruction content given by the user operation is not defined, the standard platform P1 can recognize the instruction content given by the user operation, on the basis of the position information of the touch operation on the button in the customized screen 310, and the like. In other words, relatively diverse buttons for each of which a corresponding API is not defined can be also arranged in the customized screen 310.

Further, though one aspect of the present invention in which the button 225 in the screen 220 (FIG. 5) is assigned to the button 313 in the customized screen 310 (FIG. 7) and the screen 230 (FIG. 6) is displayed in response to the pressing operation (touch operation) on the button 313 has been described in the first and second preferred embodiments, this is only one exemplary case.

There may be a case, for example, where the button 231 in the screen 230 is assigned to the button 313 in the customized screen 310 and when the pressing operation (touch operation) on the button 313 is performed, the same setting process (i.e., the setting process of “Frame Erase”) as that in response to the pressing operation on the button 231 is performed. Alternatively, there may be another case where the button 233 in the screen 230 is assigned to the button 313 in the customized screen 310 and when the pressing operation (touch operation) on the button 313 is performed, the same setting process (i.e., the setting process of “Entire Frame” (setting process “using the same set value (erase width) for top, bottom, left, and right”) as that in response to the pressing operation on the button 233 is performed. Further, as the “erase width”, for example, a default value (10 mm or the like) may be used.

### 3. The Third Preferred Embodiment

Though one aspect of the present invention in which a single instruction content is assigned to each button in the customized screen 310 (FIG. 7) has been described in the first and second preferred embodiments, this is only one exemplary case. To one button in the customized screen 310, for example, a plurality of instruction contents may be collectively assigned. In other words, a series of processes (also referred to as a workflow process) may be collectively registered to one button and when the button is pressed, a plurality of processes may be automatically and successively performed. In the third preferred embodiment, such an aspect of the present invention will be described, taking examples.

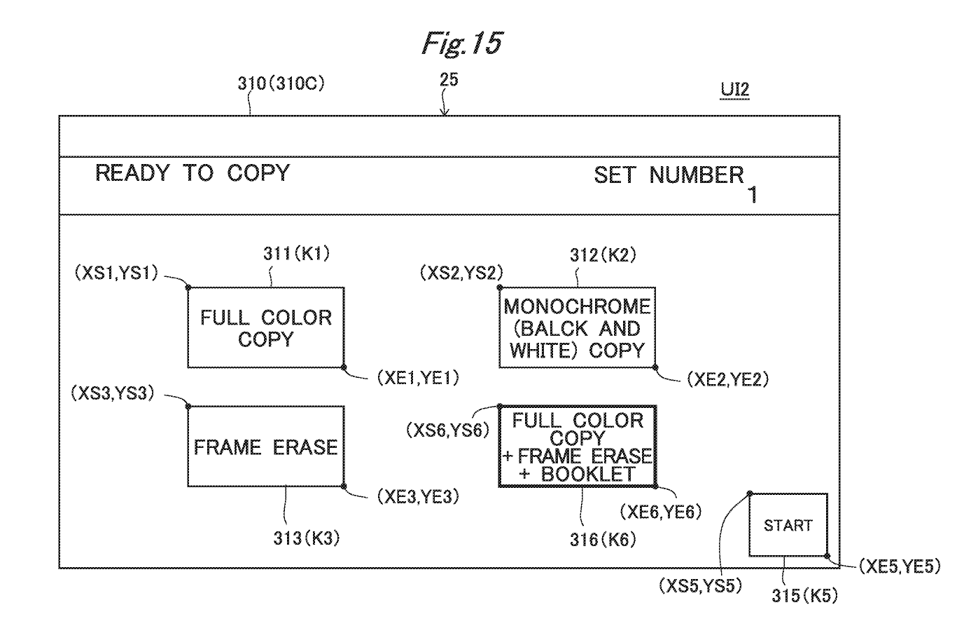

FIG. 15 is a view showing a customized screen 310 (also referred to as 310C) in accordance with the third preferred embodiment. The customized screen 310C is almost the same as the customized screen 310 (also referred to as 310A) of FIG. 7. In the customized screen 310C, however, (instead of the button 314,) a button 316 is provided. To this button 316 (K6), a function for collectively executing a plurality of setting processes is assigned. In more detail, a plurality of setting processes which a user uses in the copy operation with relatively high frequency are collectively assigned to the single button 316. Three setting processes of “Full Color”, “Frame Erase (Entire Frame)”, and “Booklet”, for example, are assigned to the button 316.

In the third preferred embodiment, the case where these three setting processes are assigned to the single button 316 in the UI builder will be described.

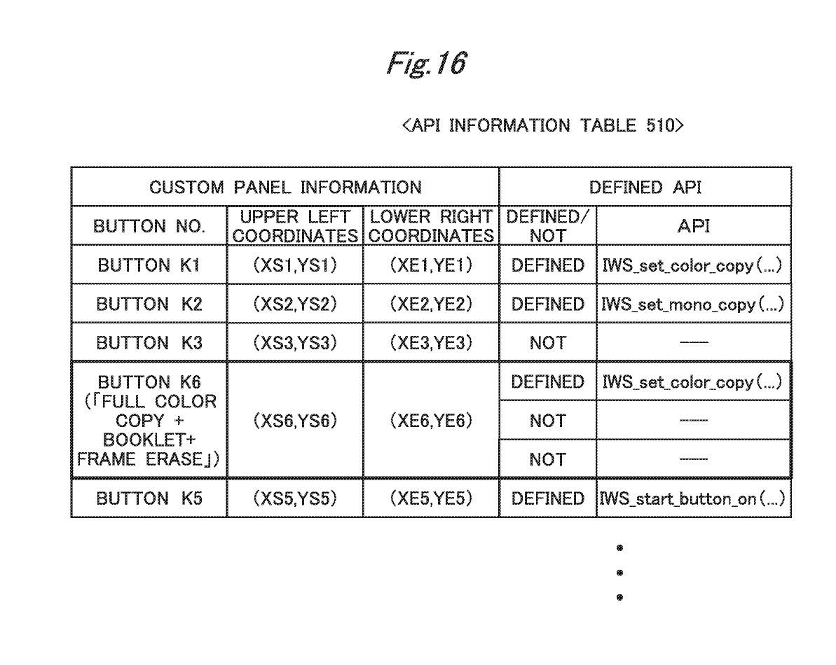

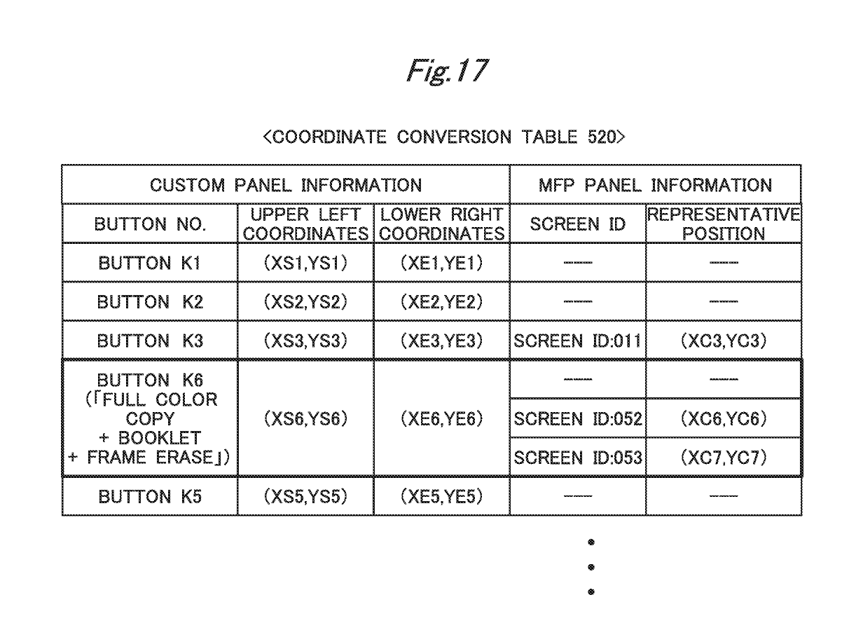

FIG. 16 is a view showing an API information table 510 of the third preferred embodiment, and FIG. 17 is a view showing a coordinate conversion table 520 of the third preferred embodiment.

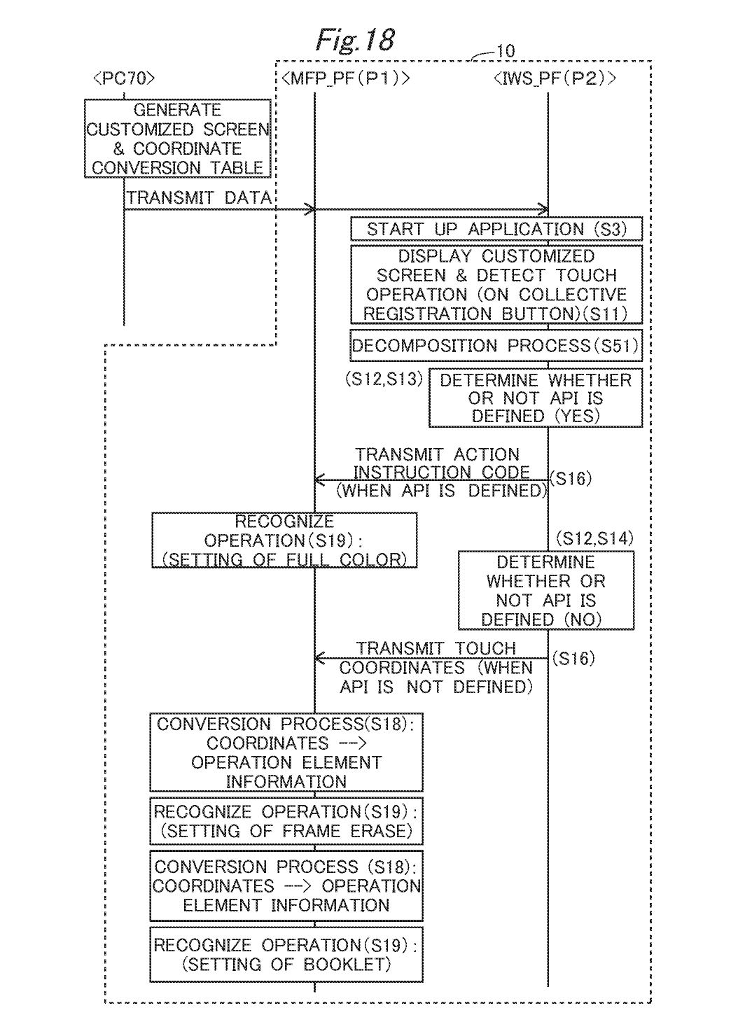

Also in the third preferred embodiment, the same process as that of FIG. 8 is performed. Immediately before Step S12 (between Steps S11 and S12), however, an operation of Step S51 (see FIG. 18) is performed. In Step S51, the IWS platform P2 decomposes and extracts a plurality of instructions (a plurality of processes) assigned to the single button 316.

In more detail, the IWS platform P2 broadly classifies the plurality of instructions (the plurality of processes) assigned to the single button 316 (K6) into two processes. One process is a setting process in the case where the corresponding API is already defined and the other process is a setting process in the case where the corresponding API is undefined. Then, for each of the two processes, the corresponding process is performed.

As to the setting process in the case where the corresponding API is already defined, the process operations of Steps S12, S13, S16, S17, and S19 (see FIG. 8) are performed in this order.

Specifically, first, on the basis of the API information table 510 (FIG. 16), it is determined that for the first instruction (the setting process on “Full Color”) among the plurality of instructions assigned to the button 316 (K6), there is a defined API (“IWS_set_color_copy”) (Step S12). Then, the IWS platform P2 determines the action instruction code (in other words, the action instruction code formed by using the API) as the information (in other words, recognition information) to be transferred to the standard platform P1, and transfers the action instruction code to the standard platform P1 (Steps S13 and S16). Receiving the action instruction code, the standard platform P1 recognizes, on the basis of the action instruction code, that the first instruction content given by the user indicates that the “Color” in the copy operation should be set to “Full Color” (Steps S17 and S19) (also see the substantially center portion of FIG. 18).

On the other hand, as to the setting process in the case where the corresponding API is undefined, the process operations of Steps S12, S14, S16, S17, S18, and S19 (see FIG. 8) are performed in this order.

Specifically, first, on the basis of the API information table 510 (FIG. 16), it is determined that for the second setting process (the setting process on “Frame Erase (Entire Frame by 10 mm (default value))”) and the third setting process (the setting process on “Booklet”), there is no defined API (Step S12). Then, for these two setting processes, the IWS platform P2 determines the touch coordinates (Xt, Yt) in the customized screen 310 as the information to be transferred to the standard platform P1, and transfers the touch coordinates (Xt, Yt) to the standard platform P1 (Steps S14 and S16).

Receiving the touch coordinates (Xt, Yt), the standard platform P1 determines that “the information on the operation position (in more detail, the operation position information)” is transferred from the IWS platform P2, and performs conversion of the information by using the coordinate conversion table 520 (FIG. 17) (Steps S17 and S18). When the standard platform P1 determines, by using the coordinate conversion table 520 of FIG. 17, that the touch coordinates (Xt, Yt) indicate a position inside the button 316 (K6), the standard platform P1 extracts two pieces of operation element information which are corresponding to the button 316. One of the two pieces of operation element information is the operation element information on the button 231 in the screen 230 (screen ID “052”), which has a representative position (XC6, YC6) (see FIG. 6). The other piece of operation element information is the operation element information on a button in a screen (not shown) with screen ID “053”, which has a representative position (XC7, YC7). Thus, the standard platform P1 converts the touch coordinates (Xt, Yt) into the two pieces of operation element information.

Then, the standard platform P1 recognizes each of the two pieces of operation element information (Step S19). Specifically, on the basis of the first one piece of operation element information (operation element information on the button 231 in the screen with screen ID “052”, which has the representative position (XC6, YC6)), the standard platform P1 recognizes that the instruction content given by the user operation includes the setting instruction of “Frame Erase”. Further, on the basis of the other one piece of operation element information (operation element information on the button in the screen with screen ID “053”, which has the representative position (XC7, YC7)), the standard platform P1 recognizes that the instruction content given by the user operation includes the setting instruction of “Booklet” (also see the lower portion of FIG. 18).

With such operations, in the MFP 10, the plurality of processes (three setting processes) assigned to the single button 316 are performed automatically and successively in response to the pressing operation of the button 316. In more detail, the processes indicated by one instruction (the full-color setting process) corresponding to the defined API and two instructions (“Frame Erase” and “Booklet”) not corresponding to any defined API are successively performed (see FIG. 18).

Thus, in the case where a plurality of instructions are assigned to the single button 316 in the IWS user interface UI2, the information to be transferred to the standard platform P1 (in other words, the recognition information) is determined for each of the plurality of instructions (Steps S51 and S12). Specifically, for the first instruction, the action instruction code (API or the like) is determined as the information to be transferred to the standard platform P1. On the other hand, for each of the second and third instructions, the information on the operation position of the user operation (touch coordinates) is determined as the information to be transferred to the standard platform P1. In other words, both the two kinds of information assigned to the single button 316 are transferred from the IWS platform P2 to the standard platform P1.

Then, on the basis of the information transferred for each of the plurality of instructions (in other words, the information determined as the recognition information for each of the plurality of instructions), the standard platform P1 recognizes the content of each of the plurality of instructions given by the user operation. In detail, when the standard platform P1 receives the action instruction code for one of the plurality of instructions, the standard platform P1 recognizes the instruction content given by the user operation on the basis of the action instruction code. Further, when the standard platform P1 receives the touch coordinates in the customized screen 310 for one of the plurality of instructions, the standard platform P1 recognizes the instruction content given by the user operation on the basis of the touch coordinates. In more detail, the standard platform P1 recognizes one or more instruction contents (for example, two instructions (“Frame Erase” and “Booklet”)) corresponding to one or more pieces of operation element information obtained after the conversion of the touch coordinates (operation position information), as some of the instruction contents given by the user operation.

With such operations, it is possible to collectively register a series of processes (also referred to as a workflow process) to a single button and perform the plurality of processes by pressing the single button. Especially, even in the case where the plurality of processes include a process relating to an undefined API, it is possible to perform the series of processes by pressing one button.

Further, especially, in the case where the touch coordinate information is transferred from the IWS platform P2 to the standard platform P1, when a plurality of processes (a plurality of setting processes corresponding to undefined APIs, or the like) are assigned to the touch coordinates, the plurality of processes are converted into the plurality of corresponding operation element information by using the coordinate conversion table 520. Then, the standard platform P1 recognizes the contents of the plurality of processes on the basis of the plurality of pieces of operation element information.

With such operations, in the case of collectively registering a series of processes to a single button and performing the plurality of processes by pressing the single button, the plurality of processes can include even two or more processes relating to the undefined APIs.

Further, though the modification of the first preferred embodiment has been described in the third preferred embodiment, this is only one exemplary case.

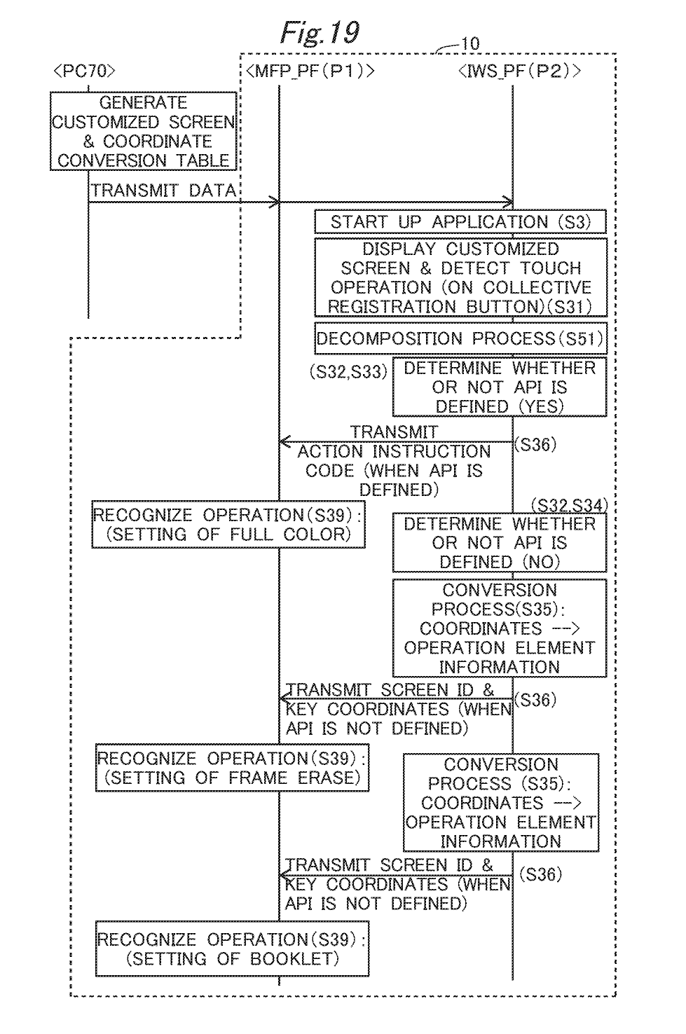

For example, the same modification can be made on the second preferred embodiment. In this case, unlike in the third preferred embodiment, the IWS platform P2 may perform conversion of the touch coordinates in the IWS user interface UI2 into the operation element information in the standard user interface UI1 by using the coordinate conversion table 520 (like in the second preferred embodiment) (see Step S35 and the like of FIG. 19).

Specifically, as to one or more instructions relating to the undefined APIs among the plurality of instructions (the plurality of processes) obtained after the decomposition in the decomposition process of Step S51 (see FIG. 18), the IWS platform P2 may convert the touch coordinates (Xt, Yt) into one or more pieces of corresponding operation element information by using the coordinate conversion table 520. By performing this operation, one or more instructions assigned to the display element button (display button) are converted into one or more pieces of operation element information. Further, in the lower portion of FIG. 19, shown are the respective conversion processes (Step S35) into the two pieces of operation element information.

Furthermore, the one or more pieces of operation element information are transferred from the IWS platform P2 to the standard platform P1. Then, on the basis of the received one or more pieces of operation element information (for example, the respective screen IDs of the plurality of corresponding operation screens relating to the plurality of operations, the respective representative positions of the plurality of corresponding buttons relating to the plurality of operations, and the like), the standard platform P1 recognizes the contents of the one or more processes. In other words, the one or more instruction contents corresponding to the one or more pieces of operation element information are recognized as some of the instruction contents given by the user operation. Then, on the basis of the recognition results, the standard platform P1 may perform the one or more processes. Further, in the lower portion of FIG. 19, shown are the two respective recognition processes (Step S39) on the basis of the two pieces of operation element information.

### 4. Variations, Etc.

Though the preferred embodiments of the present invention have been described above, the present invention is not limited to the above-described exemplary cases.

In the above-described preferred embodiments, for example, the method of transmitting the information from the standard platform P1 to the IWS platform P2 is changed depending on whether or not the API is defined. Further, in the coordinate conversion table 520, only the conversion information on some buttons (the buttons corresponding to the undefined APIs) in the customized screen 310 are specified.

Not limited to the above cases, however, the transmission of the information from the standard platform P1 to the IWS platform P2 may be performed always through the conversion process using the coordinate conversion table 520, not depending on whether or not the API is defined. In that case, however, it is required that the coordinate conversion table 520 includes not only the conversion information on some buttons (the buttons corresponding to the undefined APIs) in the customized screen 310 but also the conversion information on a relatively large number of buttons (e.g., all the buttons) relating to the customized screen 310. In terms of reduction in the amount of information in the coordinate conversion table 520, the aspects shown in the above-described preferred embodiments are preferable.

While the invention has been shown and described in detail, the foregoing description is in all aspects illustrative and not restrictive. It is therefore understood that numerous modifications and variations can be devised without departing from the scope of the invention.

What is claimed is:

1. An image forming apparatus having a first user interface operating on a first platform and a second user interface operating on a second platform and capable of being customized by a user, comprising:
a determination part for determining recognition information which is information to be used for recognizing an instruction content given by a user operation, among action instruction information based on said user operation and information on an operation position of said user operation, which are two different types of information, when said user operation is performed in a customized screen of said second user interface;
a conversion part for converting operation position information in said second user interface into operation element information which is information of a corresponding operation element in a corresponding operation screen of said first user interface when said information on said operation position of said user operation is determined as said recognition information; and
a recognition part for recognizing said instruction content given by said user operation on the basis of at least one of said action instruction information and said operation element information.

2. The image forming apparatus according to claim 1, further comprising:
an information transfer part for transferring said information determined by said determination part from said second platform to said first platform,
wherein said recognition part recognizes said instruction content given by said user operation in said second user interface, on the basis of said information transferred from said second platform to said first platform.

3. The image forming apparatus according to claim 2, wherein
said determination part determines said information to be transferred from said second platform to said first platform, among said operation position information indicating said operation position of said user operation and said action instruction information based on said user operation, which are two different types of information, when said user operation is performed in said second user interface,
said recognition part recognizes said instruction content given by said user operation on the basis of said action instruction information when said action instruction information is transferred to said first platform, and
said recognition part recognizes said instruction content given by said user operation on the basis of said operation element information obtained after conversion of said operation position information transferred to said first platform when said operation position information is transferred to said first platform.

4. The image forming apparatus according to claim 3, wherein
when said operation position information is transferred to said first platform,
said conversion part converts said operation position information indicating an operation position of said user operation for a specific display element in said second user interface into said operation element information including screen identification information of a screen having a specific corresponding display element in said first user interface, which is corresponding to said specific display element, and representative position information of said specific corresponding display element in said first user interface, on the basis of a conversion table indicating a relation between position information of some display elements in said user interface and information of respective corresponding display elements in said first user interface, which are corresponding to said some display elements, and
said recognition part recognizes said instruction content given by said user operation on the basis of said operation element information obtained after said conversion by said conversion part.

5. The image forming apparatus according to claim 3, wherein
said determination part determines one of said operation position information and said action instruction information which are two different types of information, as said information to be transferred from said second platform to said first platform, in accordance with whether or not said user operation in said second user interface is assigned to any action instruction code in advance.

6. The image forming apparatus according to claim 3, wherein
said determination part determines that said operation position information should be transferred to said first platform, when said user operation in said second user interface is not assigned to any action instruction code in advance,
said determination part determines that a specific action instruction code should be transferred to said first platform, when said user operation in said second user interface is assigned to said specific action instruction code in advance,
said recognition part recognizes said instruction content given by said user operation, on the basis of said operation element information obtained after said conversion of said operation position information, when said operation position information is transferred to said first platform, and
said recognition part recognizes said instruction content given by said user operation, on the basis of said specific action instruction code, when said specific action instruction code is transferred to said first platform.

7. The image forming apparatus according to claim 5, wherein
said determination part determines whether or not said user operation is assigned to any action instruction code in advance, on the basis of an information table for defining a display position of each of some display elements in said second user interface and an action instruction code corresponding to said each of said some display elements, being associated with each other, and said operation position of said user operation in said second user interface.

8. The image forming apparatus according to claim 5, wherein
said action instruction code is formed by using an application programming interface designed for an action instruction.

9. The image forming apparatus according to claim 3, wherein
when a plurality of instructions are assigned to one button in said second user interface,
said determination part determines information to be transferred to said platform of said first user interface for each of said plurality of instructions, and
said recognition part recognizes a content of each of said plurality of instructions given by said user operation on the basis of said information transferred for each of said plurality of instructions.

10. The image forming apparatus according to claim 9, wherein
when said operation position information is transferred to said first platform for one of said plurality of instructions,
said recognition part recognizes one or more instruction contents corresponding to one or more pieces of operation element information obtained after said conversion of said operation position information, as some of instruction contents given by said user operation.

11. The image forming apparatus according to claim 2, wherein
when said user operation is performed in said second user interface,
said determination part determines information to be transferred from said second platform to said first platform, among said information on said operation position of said user operation and said action instruction information based on said user operation, which are two different types of information,
said conversion part converts said operation position information indicating said operation position of said user operation in said second user interface into said operation element information on said corresponding operation screen in said first user interface, and generates said operation element information as said information on said operation position of said user operation, when said information on said operation position of said user operation is determined to be transferred to said first platform,
said recognition part recognizes said instruction content given by said user operation, on the basis of said action instruction information, when said action instruction information is transferred to said first platform, and
said recognition part recognizes said instruction content given by said user operation, on the basis of said operation element information obtained after conversion, when said operation element information obtained after said conversion by said conversion part is transferred to said first platform.

12. The image forming apparatus according to claim 11, wherein
said conversion part converts said operation position information indicating an operation position of said user operation for a specific display element in said second user interface into said operation element information including information of a specific corresponding display element in said first user interface, which is corresponding to said specific display element, on the basis of a conversion table indicating a relation between position information of some display elements in said user interface and information of respective corresponding display elements in said first user interface, which are corresponding to said some display elements,
said operation element information obtained after said conversion includes screen identification information of a screen having said specific corresponding display element in said first user interface and representative position information of said specific corresponding display element in said first user interface, and
said recognition part recognizes said instruction content given by said user operation, on the basis of said operation element information including said screen identification information and said representative position information of said specific corresponding display element, when said operation element information obtained after said conversion is transferred to said first platform.

13. The image forming apparatus according to claim 11, wherein
said determination part determines one of said action instruction information and said operation element information obtained after said conversion of said operation position information, which are two different types of information, as said information to be transferred from said second platform to said first platform, in accordance with whether or not said user operation in said second user interface is assigned to any action instruction code in advance.

14. The image forming apparatus according to claim 11, wherein
said determination part determines that said operation element information obtained after said conversion by said conversion part, which is said information on said operation position of said user operation, should be transferred to said first platform, when said user operation in said second user interface is not assigned to any action instruction code in advance,
said determination part determines that a specific action instruction code should be transferred to said first platform, when said user operation in said second user interface is assigned to said specific action instruction code in advance,
said recognition part recognizes said instruction content given by said user operation, on the basis of said operation element information obtained after said conversion, when said operation element information obtained after said conversion is transferred to said first platform, and
said recognition part recognizes said instruction content given by said user operation, on the basis of said specific action instruction code, when said specific action instruction code is transferred to said first platform.

15. The image forming apparatus according to claim 13, wherein
said determination part determines whether or not said user operation is assigned to any action instruction code in advance, on the basis of an information table for defining a display position of each of some display elements in said second user interface and an action instruction code corresponding to said each of said some display elements, being associated with each other, and said operation position of said user operation in said second user interface.

16. The image forming apparatus according to claim 13, wherein
said action instruction code is formed by using an application programming interface designed for an action instruction.

17. The image forming apparatus according to claim 11, wherein
when a plurality of instructions are assigned to one button in said second user interface,
said determination part determines information to be transferred to said platform of said first user interface for each of said plurality of instructions, and
said recognition part recognizes a content of each of said plurality of instructions given by said user operation on the basis of said information transferred for each of said plurality of instructions.

18. The image forming apparatus according to claim 17, wherein
when it is determined that said information on said operation position of said user operation is transferred to said first platform, for one of said plurality of instructions,
said conversion part converts said operation position information into one or more pieces of operation element information, and
said recognition part recognizes one or more instruction contents corresponding to one or more pieces of operation element information, as some of instruction contents given by said user operation.

19. A non-transitory computer-readable recording medium for recording therein a computer program to be executed by a computer embedded in an image forming apparatus to realize a first user interface operating on a first platform and a second user interface operating on a second platform and capable of being customized by a user, to cause said computer to perform the steps of;
a) determining recognition information which is information to be used for recognizing an instruction content given by a user operation, among action instruction information based on said user operation and information on an operation position of said user operation, which are two different types of information, when said user operation is performed in a customized screen of said second user interface;
b) converting operation position information in said second user interface into operation element information which is information of a corresponding operation element in a corresponding operation screen of said first user interface when said information on said operation position of said user operation is determined as said recognition information; and
c) recognizing said instruction content given by said user operation on the basis of at least one of said action instruction information and said operation element information.

20. The non-transitory computer-readable recording medium according to claim 19, wherein
said step a) has the step of;
a-1) determining information to be transferred from said second platform to said first platform, among said operation position information indicating said operation position of said user operation and said action instruction information based on said user operation, which are two different types of information, when said user operation is performed in said second user interface,
said step b) has the steps of;
b-1) transferring said information determined in said step a) from said second platform to said first platform; and
b-2) converting said operation position information in said second user interface into said operation element information on said corresponding operation screen in said first user interface, and
said step c) has the steps of;
c-1) recognizing said instruction content given by said user operation, on the basis of said action instruction information, when said action instruction information is transferred to said first platform; and
c-2) recognizing said instruction content given by said user operation, on the basis of said operation element information obtained after conversion of said operation position information transferred to said first platform, when said operation position information is transferred to said first platform.

21. The non-transitory computer-readable recording medium according to claim 19, wherein
said step a) has the step of;
a-1) determining information to be transferred from said second platform to said first platform, among said information on said operation position of said user operation and said action instruction information based on said user operation, which are two different types of information, when said user operation is performed in said second user interface,
said step b) has the steps of;
b-1) converting said operation position information indicating said operation position of said user operation in said second user interface into said operation element information on said corresponding operation screen in said first user interface and generating said operation element information as said information on said operation position of said user operation, when said information on said operation position of said user operation is determined to be transferred to said first platform; and
b-2) transferring at least one of said action instruction information and said operation element information obtained after conversion in said step b-1), which is said information determined in said step a) as said recognition information, from said second platform to said first platform, and
said step c) has the steps of;
c-1) recognizing said instruction content given by said user operation, on the basis of said action instruction information, when said action instruction information is transferred to said first platform; and
c-2) recognizing said instruction content given by said user operation, on the basis of said operation element information, when said operation element information obtained after said conversion is transferred to said first platform.

22. A non-transitory computer-readable recording medium for recording therein a computer program to be executed by a computer embedded in an image forming apparatus to realize a first user interface operating on a first platform and a second user interface operating on a second platform and capable of being customized by a user, to cause said computer to perform the steps of;
a) determining information to be transferred from said second platform on which said second user interface operates to said first platform on which said first user interface operates, among information on an operation position of a user operation and action instruction information based on said user operation, which are two different types of information, when said user operation is performed in a customized screen of said second user interface;
b) converting operation position information indicating said operation position of said user operation in said second user interface into operation element information on a corresponding operation screen in said first user interface and generating said operation element information as said information on said operation position of said user operation, when said information on said operation position of said user operation is determined to be transferred to said first platform; and
c) transferring at least one of said action instruction information and said operation element information obtained after conversion in said step b), which is said information determined in said step a), from said second platform to said first platform, as recognition information which is information to be used in said first user interface for recognizing an instruction content given by said user operation performed in said second user interface.
